(19) United States
(12) Patent Application Publication
(10) Pub. No.: US 2014/0373167 A1
(43) Pub. Date: Dec. 18, 2014

(54) TRACE CENTER APPARATUS AND METHOD FOR ENABLING CONTENTS TO BE TRACED

(71) Applicant: NIPPON TELEGRAPH AND TELEPHONE CORPORATION, Tokyo (JP)

(72) Inventors: Takahiro Matsumura, Tokyo (JP); Toshihiro Motoda, Tokyo (JP); Shinichi Nakahara, Tokyo (JP)

(73) Assignee: NIPPON TELEGRAPH AND TELEPHONE CORPORATION, Tokyo (JP)

(21) Appl. No.: 14/373,667

(22) PCT Filed: Aug. 8, 2013
(86) PCT No.: PCT/JP2013/071481

§ 371 Date: Jul. 22, 2014

(30) Foreign Application Priority Data
Aug. 9, 2012 (JP) 2012-176888
Aug. 21, 2012 (JP) 2012-182083
Aug. 23, 2012 (JP) 2012-184215
Sep. 13, 2012 (JP) 2012-201312

(51) Int. Cl. G06F 21/60

(52) U.S. Cl. CPC G06F 21/60
USPC 726/26

(57) ABSTRACT

A leaked information tracing technique enabling a recipient of leaked information to be identified. A trace center apparatus includes a tracer generation and registration part which issues a tracer identification number uniquely identifying both of a content residing on different computer and a tracer, generates a tracer program having the function of reporting identification information of a computer on which the content resides and the tracer identification number to a trace center, and registers the tracer program with the trace center.

### TECHNICAL FIELD

The present invention relates to an information security technique and, in particular, to a technique for tracing information leaked from a computer system to a recipient of the leaked information.

### BACKGROUND ART

There are systems that, when technical information leakage occurs, narrow down and identify leak source information and narrow down and identify a leaker of the information. There are methods for quantitatively determining the degree of matching of leaked information with information on possible leak sources and narrowing down and identifying leak source information, thereby reducing the human workload involved in the identification. Patent literature 1 describes a system that quantitatively identifies a possible leak source and identifies a possible leaker from an access log. The technique described in Patent literature 1 replaces a content including information that is likely to leak with a tracing agent to allow a leaker to acquire the information and the tracing agent reports information about the recipient of the leaked information.

There are also many techniques for servers to authenticate contents. For example, Patent literature 2 describes a system that authenticates web contents that meet certain authentication criteria.

### PRIOR ART LITERATURE

### Patent Literature

Patent literature 1: Japanese Patent Application Laid Open No. 2003-076662
Patent literature 2: Japanese Patent Application Laid Open No. 2009-301240

### SUMMARY OF THE INVENTION

### Problems to be Solved by the Invention

However, the existing techniques described above cannot identify the recipient of leaked information in the event of information leakage.

In light of the problem with the existing techniques described above, a first object of the present invention is to provide a trace center apparatus capable of identifying a recipient of leaked information and a method for enabling contents to be traced.

With the existing techniques described above, a content can be acquired before the content is replaced with the tracing agent, making tracing impossible. Furthermore, there is a possibility that tricks to circumvent attempts to trace may be used.

A second object of the present invention is to provide a trace center apparatus capable of identifying a recipient of leaked information without being inhibited from tracing and a method for enabling a content to be traced.

The existing techniques described above also have the following problems:

(1) A content can be acquired before the content is replaced with a tracing agent, making tracing impossible.
(2) Division of roles in tracing transactions, including a billing transaction, among users (hereinafter sometimes also referred to players) of a leaked information tracing system is not established.

A third object of the present invention is to provide a trace center apparatus which is capable of identifying a recipient of leaked information and for which a flow of tracing transactions, including a billing transaction, among players is established and a method for enabling a content to be traced.

The existing techniques described above have another problem that a content to be authenticated is not a program that traces leaked information to a leak recipient.

If a content is accompanied by a program that traces leaked content information to a leak recipient (hereinafter the program is sometimes also referred to as a tracer), the author of the content can advantageously trace the content to a copy destination. However, if a user who has happened to pick up the content including the tracer on the network without any malicious intent casually opens the content, information about the user's computer will be revealed to an outsider. If the user can know that the recipient of the revealed information is a safe third party, the user would feel safe even if the information is revealed to the outsider. It is also desirable that, before the content is opened to cause the tracer to reveal the information to the outsider, the user be allowed to choose not to open the content if the user does not want to reveal the information. Authentication and registration of the program (tracer) that traces leaked content information to a leak recipient has the problem described above.

A fourth object of the present invention is to provide a trace center apparatus allowing the author of a content to trace the content to a copy destination while allowing a general user to feel safe to use the content with approving that the user will be identified as a copy destination or to choose not to use the content if the user does not want to be identified as a copy destination, and a method for enabling a content to be traced.

### Means to Solve the Problems

Means to achieve the first object of the present invention will be described below.

The idea is to solve the problem by a configuration in which if a content is leaked, the content itself informs where the content is located. In particular, a program (hereinafter referred to as a tracer) that reports computer identification information such as an IP address of a computer and an identification number of the program is added to the content. This enables leaked information to be traced when the computer on which the information is stored is connected to a network such as the Internet or a LAN because the tracer is activated by a trigger such as opening the file of the content, acquires an IP address, MAC address or UUID of the computer or an identification number of the device such as a mobile phone on which the leaked information is stored and reports the identification number of the tracer, the IP address or the like of the leak recipient computer and time through the network to the computer from which the information has been leaked, a trace center, a server at a public institution, an antivirus software server, or the like so that the leaked information being transferred from one location to another can be traced. The tracer may be configured to acquire a log of access to files on a leak recipient computer and provide the log to a trace center. Furthermore, the tracer may be configured to have the function of encrypting information including the identification number of the tracer, time, and a file access log information on the leak recipient computer and storing the encrypted information.

A trace center may include a tracer generation and registration part which, when receiving a content from a computer, issues a tracer identification number, generates a tracer having the function of reporting identification information of a computer on which the content resides and the tracer identification number, includes the tracer into the content to generate a tracer-containing content, registers the tracer-containing content, and sends the tracer-containing content to the computer, and a report accepting part which receives identification information concerning a different or the same computer which is acquired by and sent from the tracer in the content which is activated after the tracer-containing content has been copied on the different or the same computer, together with the tracer identification number. The trace center and the tracer-containing content may constitute a leaked information tracing system. The identification number of the tracer may be an identification number that can uniquely identify both of the content to be traced and the tracer. For example, a unique identification number may be issued for the content, a different unique identification number may be issued for the tracer, and the combination of the unique identification number for the content and the unique identification number for the tracer may be used as the identification number of the tracer.

The tracer generation and registration part may register with the trace center any of the following seven items: the tracer program, the tracer-containing content, the body of the content, and the combinations of these.

Identification information concerning a computer acquired by the tracer includes position information such as GPS information of a mobile phone.

The trace center may be configured with an additional program sending part which sends an additional program that the tracer can embed in the tracer to the tracer so that the tracer can receive the additional program at the tracer generation and registration part from the additional program sending part and can embed the additional program in the tracer. The trace center and the tracer-containing content may constitute a leaked information tracing system.

If access to files can be logged on a leak recipient computer by an access monitoring software or a tracer that has the function of logging access to files, access log information relating to a content may be sent from the leak recipient computer to the trace center and may be compared with previous information from the tracer so that even if the leaked content has been edited and modified, the edited and modified content can be identified as the leaked information.

To cope with the possibility that a tracer-containing content including a tracer may be removed as malware by antivirus software, which is in widespread use, a malware list for an antivirus software center that the antivirus software distributes can be created in such a way that the tracer is not listed on the malware list to prevent the tracer-containing content from being removed.

Furthermore, when the tracer generation and registration part generates a tracer, the tracer generation and registration part may insert a unique string of characters and numerics in the code of the tracer as a content signature so that when antivirus software detects the signature, the antivirus software considers the tracer as a registered tracer and does not remove the tracer.

Means for achieving the second object of the present invention will be described below.

The idea is to solve the problem by a configuration in which if a content is leaked, the content itself informs where the content is located and the informing function is included in an action required for opening the content, so that the informing function is not inhibited by an operation of a leak recipient computer.

In particular, for the informing function, a program (hereinafter referred to as a tracer) that reports computer identification information such as an IP address of a computer and an identification number of the tracer is added to the content. This enables leaked information to be traced when the computer on which the information is stored is connected to a network such as the Internet or a LAN because the tracer is activated by a trigger such as opening the file of the content, acquires an IP address, MAC address or UUID of the computer on which the leaked information is stored and if possible, position information and a user name, and reports the identification number of the tracer, the IP address, MAC address or the like of the leak recipient computer, the user name and time through the network to the computer from which the information has been leaked, a trace center, a server at a public institution, an antivirus software server, or the like so that the leaked information being transferred from one location to another can be traced.

The tracer may be configured to acquire a log of access to files on a leak recipient computer and provide the log to a trace center. Furthermore, the tracer may be configured to have the function of encrypting information including the identification number of the tracer, time, and a file access log information on the leak recipient computer and storing the encrypted information in the leak recipient computer. A configuration is possible in which the tracer has the file access log function on a leak recipient computer so that the tracer can acquire a log of access to files on the leak recipient computer and send the access log information relating to the content from the leak recipient computer to the trace center, where the access log information can be compared with previous information sent from the tracer to identify an edited and modified content as leaked information even if the leaked content has been edited and modified.

The configuration in which the informing function described above is not inhibited can be implemented by configuring the content in an executable format that cannot be accessed unless some preprocessing is performed. For example, the content may be implemented in a self-extracting format and the informing function may be configured so that the informing function is executed during the preprocessing such as self-extract. In order for a user to access the content, the user needs to execute the preprocessing, namely self-extract. Upon execution of the preprocessing, the informing function is activated in the preprocessing to acquire an IP address or MAC address of the computer, a user name or the like and provide the acquired information to the trace center or the like through a network. The preprocessing is completed after the information is reported, so that the informing function is executed transparently to the user and therefore the informing function is not inhibited by an operation by the user. The preprocessing is not limited to self-extract; the preprocessing may be decryption of an encrypted content or may be a process for obtaining the right to use the content or may be user authentication. The preprocessing may be any processing that users generally consider as necessary for accessing a content.

Note that in a configuration, a screen may be displayed before execution of preprocessing such as self-extract that indicates that a tracer is embedded in the content and if the preprocessing is executed, a process for acquiring identification information of the user's computer and reporting the identification information to a trace center will be executed and a screen for asking the user whether or not to approve the execution may be displayed. If the user does not approve the execution, the rest of the process may be aborted to prevent the content from being accessed.

Furthermore, after the user is allowed to access the content, the user may be prevented from storing the content as a separate file or the like on the user's computer.

Means for achieving the third object of the present invention will be described below.

The idea is to solve the problem by a configuration in which if a content is leaked, the content itself informs where the content is located and the informing function is included in an action required for opening the content, so that the informing function is not inhibited by an operation of a leak recipient computer.

In particular, for the informing function, a program (hereinafter referred to as a tracer) that reports computer identification information such as an IP address of a computer and an identification number of the tracer is added to the content. This enables leaked information to be traced when the computer on which the information is stored is connected to a network such as the Internet or a LAN because the tracer is activated by a trigger such as opening the file of the content, acquires an IP address, MAC address of the computer on which the leaked information is stored and a user name, and reports the identification number of the tracer, the IP address, MAC address or the like of the leak recipient computer, the user name and time through the network to the computer from which the information has been leaked, a trace center, a server at a public institution, an antivirus software server, or the like so that the leaked information being transferred from one location to another can be traced.

The tracer may be configured to acquire a log of access to files on a leak recipient computer and provide the log to a trace center. Furthermore, the tracer may be configured to have the function of encrypting information including the identification number of the tracer, time, and a file access log information on the leak recipient computer and storing the encrypted information in the leak recipient computer. A configuration is possible in which the tracer has the file access log function on a leak recipient computer so that the tracer can acquire a log of access to files on the leak recipient computer and send the access log information relating to the content from the leak recipient computer to the trace center, where the access log information can be compared with previous information sent from the tracer to identify an edited and modified content as leaked information even if the leaked content has been edited and modified.

The problem of establishing division of roles in tracing transactions, including a billing transaction, among players is addressed as follows. Instead of a user of an information source computer A paying a registration fee, a content with a tracing function is generated at a trace center and is sent to the information source computer A, where the content is stored. If the tracer-containing content on the information source computer A is acquired through unauthorized access and is stored on a different computer B, the tracing function is activated in response to an operation such as opening the content, and identification information of the computer B is reported to the trace center. The trace center reports the fact that information has been leaked and a report fee to the information source computer A. When the report fee is paid, identification information of the leak recipient computer B is reported to the information source computer A. There may be a situation where a tracer-containing content residing on the information source computer A has been acquired through some route and the person who has acquired the content is not malicious and wants to check the identity of the content. If the person wants to check the identity of the content, the person may send the content to the trace center together with an identity check fee. The trace center may check the content against contents registered in the trace center to find an identical or nearly identical one and may report the result of the identity check to the computer B. The trace center reports the request for the identity check and a report fee to the information source computer A. When the report fee is paid, the trace center may report details of the identity check request and the result of the identity check to the computer A.

Means for achieving the fourth object of the present invention will be described below.

First, a trace center that generates a tracer program which traces a content to a copy destination (hereinafter the tracer program is simply referred to as a tracer) and with which the tracer is to be registered. An electronic signature that certificates that the tracer is generated by the trace center is added to the tracer. This helps verify the identity of the tracer when the content is copied later because the tracer is also copied together with the content.

Specifically, a tracer generation and registration part is provided at the trace center that when receiving a content from a computer, issues a tracer identification number, generates a tracer having the function of reporting identification information of a computer on which the content resides and the tracer identification number, adds an electronic signature to the tracer by using a secret key of the trace center, includes the tracer with the electronic signature in the content, registers the tracer with the electronic signature or the content including the tracer with the electronic signature, and sends the content including the tracer with the signature to the computer. The purpose of the provision of the tracer generation and registration part is to generate a tracer with a signature and attach the tracer to the content. The tracer generation and registration part may register information concerning a sender of the content in the trace center.

A communication processing part is provided that receives identification information concerning a different or the same computer sent along with a tracer identification number sent from a tracer in a content that is activated after the tracer-containing content has been copied on the different or the same computer. The purpose is to identify a copy destination.

Furthermore, a signature verification part is provided at the trace center that is configured to verify the signature of a tracer with the signature by using a public key of the trace center and send the result of the verification to the tracer. The purpose is to verify the identity of the tracer.

The tracer generation and registration part configures the tracer so that the tracer is activated before the body of the content is disclosed. In order to disclose the body of the content, the tracer asks a user for approval of reporting identification information of the user's computer and the tracer identification number to the trace center. If the user approves the reporting, the tracer sends the tracer with a signature to the trace center. When the tracer receives verification by the signature verification part of the trace center that the signature of the tracer has been added by the trace center, the tracer discloses the body of the content to the user. The purpose is to relieve general user's concern described earlier as the problem to be solved.

The tracer is configured by the tracer generation and registration part so that if the user does not approve reporting the identification information of the user's computer and the tracer identification number to the trace center for disclosure of the body of the content, the body of the content is not disclosed to the user.

Another approach is conceivable. Instead of adding an electronic signature to a tracer at the trace center, a content is encrypted and, instead of a tracer sending the tracer with a signature from a user's computer to the trace center, the tracer sends the encrypted content to the trace center, where the encrypted content is decrypted, thereby allowing the user to understand that the content has been encrypted by the trace center, that is, the content is reliable.

Specifically, a tracer generation and registration part is provided at the trace center that when receiving a content from a computer, issues a tracer identification number, generates a tracer having the function of reporting identification information of a computer on which the content resides and the tracer identification number, encrypts the content by using a public key of the trace center, includes the tracer into the encrypted content to generate an encrypted tracer-containing content, and sends the encrypted tracer-containing content to the computer.

Furthermore, a communication processing part is provided that receives identification information concerning a different or the same computer sent along with a tracer identification number sent from a tracer in an encrypted content that is activated after the encrypted tracer-containing content has been copied on the different or the same computer.

Furthermore, a decryption part is provided at the trace center that is configured to receive an encrypted content from a tracer, decrypts the encrypted content using a secret key of the trace center, and sends the decrypted content to the tracer.

The tracer generation and registration part configures the tracer so that the tracer is activated before the encrypted content is decrypted. In order to decrypt the encrypted content to disclose the body of the content, the tracer asks a user for approval of reporting identification information of the user's computer and the tracer identification number to the trace center. If the user approves the reporting, the tracer sends the encrypted content to the trace center, receives the content decrypted by the trace center, and discloses the body of the content to the user.

The tracer is configured by the tracer generation and registration part so that if the user does not approve reporting the identification information of the user's computer and the tracer identification number to the trace center for disclosure of the body of the decrypted content, the body of the content is not disclosed to the user.

Note that the tracer generation and registration part may configure a tracer so that the tracer acquires a UUID or position information of a computer on which a content resides and sends the UUID or the position information to the trace center.

In a business model, an authentication fee may be charged for adding an electronic signature to a tracer, a verification fee may be charged for verifying a tracer with a signature, or a decryption fee may be charged for decrypting an encrypted content.

The tracer generation and registration part may be configured to register a tracer-containing content and send the tracer-containing content to a computer on condition that a registration fee is paid by the sender of the content.

The signature verification part may be configured to verify a signature of a tracer with the signature by using a public key of the trace center and may send the result of the verification to the tracer on condition that a verification fee is paid by the user.

The decryption part may be configured to receive an encrypted content from a tracer with a signature and, on condition that a decryption fee is paid by the user, may decrypt the encrypted content using a secret key of the trace center and may send the decrypted content to the tracer.

A trace center apparatus according to a first aspect of the present invention is a trace center apparatus including a tracer generation and registration part issuing a tracer identification number that uniquely identifies a content residing on a different computer and also uniquely identifies a tracer, generating a tracer program having the function of reporting identification information of a computer on which a content resides and the tracer identification number to a trace center while holding the trace identification number, and registering the tracer program with the trace center.

A trace center apparatus according to a second aspect of the present invention is a trace center apparatus according to the first aspect in which the tracer generation and registration part is configured to receive the content from the different computer, include the tracer program in the content to generate a tracer-containing content, register the tracer-containing content with the trace center, and send the tracer-containing content to the different computer.

A trace center apparatus according to a third aspect of the present invention is a trace center apparatus according to the first aspect in which the tracer generation and registration part is configured to send the tracer program to the different computer and to include the tracer program in the content to generate a tracer-containing content on the different computer.

A trace center apparatus according to a fourth aspect of the present invention is a trace center apparatus according to the second or third aspect further including an information receiving part receiving computer identification information and a tracer identification number sent from a tracer which is activated and acquires the identification information concerning the computer after a content including the tracer is copied on a different or the same computer.

A trace center apparatus according to a fifth aspect of the present invention is a trace center apparatus according to the fourth aspect including an additional program sending part sending an additional program embeddable in the tracer to the tracer program, wherein in the tracer generation and registration part, the tracer program is configured to receive the additional program from the additional program sending part and is capable of embedding the additional program in to the tracer program, and is configured to acquire system environment information of the different computer and send the system environment information to the trace center; and the additional program sending part is configured to select a type of an additional program to be sent to the tracer program in accordance with the received system environment information of the different computer.

A trace center apparatus according to a sixth aspect of the present invention is a trace center apparatus according to the fourth aspect in which when the trace center apparatus receives a registration fee from a user, the tracer generation and registration part generates the content including a tracing function, registers the content including the tracing function, and sends the content including the tracing function to the user and, when the trace center apparatus receives a report fee from the user, the tracer generation and registration part reports identification information of a leak recipient computer to the user.

A trace center apparatus according to a seventh aspect of the present invention is a trace center apparatus according to the fourth aspect including a billing part providing a notification of a registration fee or a report fee to a relevant computer and receiving a payment from the relevant computer, and a report processing part reporting at least an identification number of a leak recipient computer to an information source computer.

A trace center apparatus according to an eighth aspect of the present invention is a trace center apparatus according to the fourth aspect in which when a the trace center apparatus receives the content from a computer, the tracer generation and registration part issues the tracer identification number, generates the tracer having the function of reporting identification information of a computer on which the content resides and the tracer identification number, adds an electronic signature to the tracer by using a secret key of the trace center, includes the tracer with the signature into the content, registers the tracer with the signature or the content including the tracer with the signature, and sends the content including the tracer with the signature to the computer, the trace center apparatus comprises a signature verification part configured to verify the signature of the tracer with the signature by using a public key of the trace center and send the result of the verification to the tracer, the tracer is configured in the tracer generation and registration part so as to be activated before a body of the content is disclosed, the tracer is configured to ask for approval of reporting identification information of the user's computer and the tracer identification number to the trace center in order that the body of the content can be disclosed, the tracer is configured to send the tracer with the signature to the trace center if the user approves the reporting, and is configured to disclose the body of the content to the user if the tracer receives an indication that the signature verification part of the trace center has successfully verified that the signature of the tracer has been added by the trace center.

A trace center apparatus according to a ninth aspect of the present invention is a trace center apparatus according to the first or fourth aspect, wherein in the tracer generation and registration part, a content is reconstructed, on the basis of the content, in an executable format that prevents access to the content unless certain preprocessing is executed and the tracer program is configured so as to be activated during the preprocessing.

A trace center apparatus according to a tenth aspect of the present invention is a trace center apparatus according to the ninth aspect, wherein in the tracer generation and registration part, the content is reconstructed in a self-extract format on the basis of the content.

A method for enabling a content to be traced according to a eleventh aspect of the present invention includes the steps of issuing a tracer identification number uniquely identifying a content residing on a different computer and also uniquely identifying a tracer, generating a tracer program including the function of reporting identification information of a computer on which the content resides and the trace identification number to a trace center while holding the tracer identification number, and registering the tracer program with the trace center.

### Effects of the Invention

According to the present invention, if a content is leaked, the content itself informs its location so that a recipient of the leaked content can be identified.

According to the present invention, if a content is leaked, the content itself informs its location and the informing function cannot be inhibited by an operation on a leak recipient computer. Thus, the recipient of leaked information can be identified and tracing of the information cannot be inhibited.

Furthermore, according to the present invention, if a content is leaked, the content itself informs its location so that leaked information can be traced to a leak recipient. Moreover, division of roles in tracing transactions, including a billing transaction, among players can be established.

According to the present invention, the holder of the copyright of a content can trace the content to a copy recipient while general users can feel safe to choose to use the content with approving that the user will be identified as a copy destination or choose not to use the content if the user does not want to be identified as a copy recipient.

### BRIEF DESCRIPTION OF THE DRAWINGS

FIG. 1 is block diagram illustrating an example of a leaked information tracing system according to a first embodiment;

FIG. 2 is a block diagram illustrating an example of a leaked information tracing system according to a second embodiment;

FIG. 3 is a block diagram illustrating an example of a leaked information tracing system according to a third embodiment;

FIG. 4 is a flowchart illustrating an example of a leaked information tracing system according to the first embodiment;

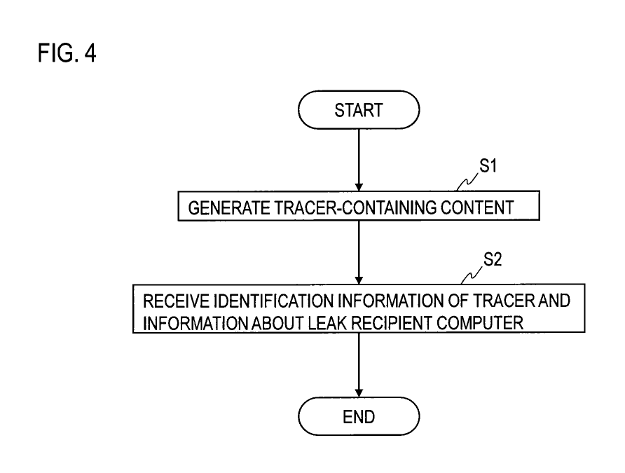

FIG. 5 is a block diagram illustrating a variation of an information receiving part;

FIG. 6 is a block diagram illustrating a variation of the information receiving part;

FIG. 7 is a diagram illustrating an example of a procedure for generating and registering a tracer-containing content;

FIG. 8 is a diagram illustrating an example of a procedure for generating and registering a tracer-containing content;

FIG. 9 is a diagram illustrating an example of an informing procedure performed by a tracer;

FIG. 10 is a diagram illustrating an example of an informing procedure performed by a tracer;

FIG. 11 is a diagram illustrating an example of a tracing procedure when a leaked content has been edited and modified;

FIG. 12 is a diagram illustrating an example of a procedure for generating and registering a tracer-containing content;

FIG. 13 is a block diagram illustrating an example of a leaked information tracing system according to a fifth embodiment;

FIG. 14 is a diagram illustrating an example of a program processing structure for a tracer-containing content;

FIG. 15 is a diagram illustrating an example of a procedure for generating and registering a tracer-containing content;

FIG. 16 is a diagram illustrating a reporting procedure performed by a tracer-containing content;

FIG. 17 is a block diagram illustrating an example of a leaked information tracing system according to a seventh embodiment;

FIG. 18 is a diagram illustrating an example of a procedure for generating and registering a tracer-containing content;

FIG. 19 is a diagram illustrating an example of a procedure for a tracer-containing content to report an information leakage;

FIG. 20 is a diagram illustrating an example of a flow of transactions among players in the leaked information tracing system according to the seventh embodiment;

FIG. 21 is a diagram illustrating an example of a flow of transactions among players in the leaked information tracing system according to the seventh embodiment;

FIG. 22 is a block diagram illustrating an example of a tracer authentication system according to an eighth embodiment;

FIG. 23 is a diagram illustrating an example of a generation and registration procedure performed on a trace center apparatus according to the eighth embodiment;

FIG. 24 is a diagram illustrating an example of a process procedure performed by a tracer according to the eighth embodiment;

FIG. 25 is a diagram illustrating an example of a signature verification procedure performed on the trace center apparatus according to the eighth embodiment;

FIG. 26 is a block diagram illustrating an example of a tracer authentication system according to a ninth embodiment;

FIG. 27 is a diagram illustrating an example of a generation and registration procedure performed on a trace center apparatus according to the ninth embodiment;

FIG. 28 is a diagram illustrating an example of a process procedure performed by a tracer according to the ninth embodiment; and

FIG. 29 is a diagram illustrating an example of a decryption procedure performed on the trace center apparatus according to the ninth embodiment.

### DETAILED DESCRIPTION OF THE EMBODIMENTS

Embodiments of the present invention will be described below with reference to drawings.

### First Embodiment

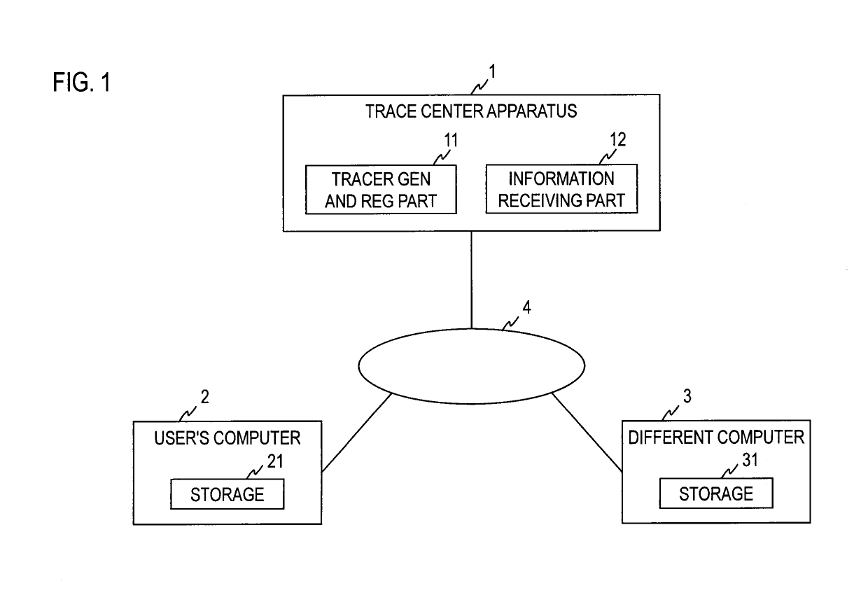

A leaked information tracing system according to a first embodiment includes, for example, a trace center apparatus 1 as illustrated in FIG. 1. A user's computer 2 and a different computer 3 are connected to the trace center apparatus 1 through a network 4 such as the Internet or a LAN (Local Area Network). It should be noted that the trace center apparatus 1 and the user's computer 2 may be referred to as different computers in the claims.

The trace center apparatus 1 includes a tracer generation and registration part 11 and an information receiving part 12, for example, as illustrated in FIG. 1.

The tracer generation and registration part 11 of the trace center apparatus 1 receives a content to trace in the event of leakage and adds a tracer to the received content to generate a tracer-containing content (step S1). The tracer-containing content is provided to the user's computer 2.

As will be described later, the tracer is a program that, if a content is leaked, sends identification information of the tracer and information about a leak recipient computer to the trace center apparatus 1. The tracer may be sometimes referred to as a tracer program.

The tracer generation and registration part 11 receives a content to trace in the event of leakage of the content from the user's computer 2 through the network 4, for example. Of course, the tracer generation and registration part 11 may receive a content to trace in the event of leakage through other means such as receiving through a recording medium such as a semiconductor memory, an optical disc or the like.

Similarly, the tracer generation and registration part 11 sends a tracer-containing content to the user's computer 2 through the network 4, for example, to provide the content to the user's computer 2. Of course, the tracer generation and registration part 11 may provide the tracer-containing content to the user's computer 2 through other means such as receiving through a recording medium such as a semiconductor memory, an optical disc or the like.

The tracer generation and registration part 11 may issue identification information of a tracer and may include the identification information in the tracer. In that case, the tracer including the identification information is added to a content. The identification information of a tracer may be a tracer identification number that can uniquely identify a content residing on the user's computer 2 and a different computer 3 and can also uniquely identify a tracer. The tracer generation and registration part 11 may register at least one of a generated tracer, a generated tracer-containing content, a file name of a generated tracer-containing content.

The tracer-containing content received from the tracer generation and registration part 11 is stored in a storage 21 of the user's computer 2.

It is assumed here that a tracer-containing content has been leaked from the user's computer 2 and stored in a storage 31 of a different computer 3. For example, a tracer-containing content may be leaked from the user's computer 2 to a different computer 3 through an unauthorized access to the user's computer 2 by an intruder.

When the tracer-containing content is opened on the different computer 3, the tracer included in the content is activated.

The tracer sends identification information of the tracer and information about the different computer 3 to the trace center apparatus 1 and the information receiving part 12 receives these items of information (step S2). The information about the different computer 3 is a network address of the different computer 3 such as an IP address, a MAC address, or the like or identification information of the different computer 3 such as a UUID. If the different computer 3 is a mobile phone, the information about the different computer 3 may be an individual identification number of the mobile phone.

The information receiving part 12 notifies the user's computer 2 of the information leakage. In doing so, the information receiving part 12 may send all or part of the information received from the tracer to the user's computer 2 as necessary.

In this way, a tracer added to a content sends identification information of the tracer and information about a leak recipient different computer 3 from the different computer 3 to the trace center apparatus 1 to enable the recipient of the leaked information to be identified.

If a tracer-containing content is transferred to two or more computers from one computer to another, the identification information of the tracer and information about the computers to which the content has been leaked are sent from the two or more computers to the trace center apparatus 1 to enable the recipients of the information transferred from one computer to another and the route to be identified.

### Second Embodiment

There is a possibility that a content to which a tracer is added may be removed as malware by antivirus software, which is in widespread use. A leaked information tracing system according to a second embodiment has the following configuration to prevent a tracer-containing content from being removed by antivirus software.

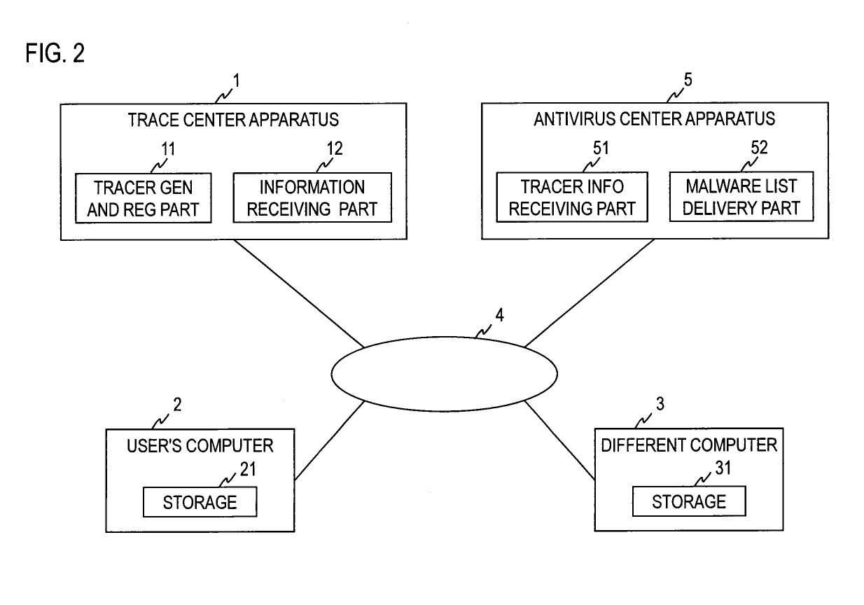

The leaked information tracing system according to the second embodiment differs from the leaked information tracing system according to the first embodiment in that the leaked information tracing system according to the second embodiment includes an antivirus center apparatus 5 as illustrated in FIG. 2. The following description will focus on differences from the leaked information tracing system according to the first embodiment and the description of elements that are similar to those of the first embodiment will be omitted.

The antivirus center apparatus 5 includes a tracer information receiving part 51 and a malware list delivery part 52, for example.

A tracer generation and registration part 11 of a trace center apparatus 1 sends information about a tracer to the antivirus center apparatus 5. Information about a tracer is information concerning the tracer such as identification information of the tracer.

The trace information receiving part 51 of the antivirus center apparatus 5 acquires information about the tracer from the trace center apparatus 1.

Then the malware list delivery part 52 of the antivirus center apparatus 5 distributes a malware list excluding the tracer about which the information has been acquired. Specifically, the malware list delivery part 52 checks an existing malware list for the tracer and, if the tracer is on the list, excludes the tracer from the existing malware list and distributes the malware list excluding the tracer. If the tracer is not on the existing malware list, the malware list delivery part 52 distributes the existing malware list as is.

Excluding a tracer from a malware list to distribute in this way can prevent a content including the tracer from being removed by antivirus software.

### Third Embodiment

Like the leaked information tracing system of the second embodiment, a leaked information tracing system according to a third embodiment is capable of preventing a tracer-containing content from being removed by antivirus software.

The following description will focus on differences from the leaked information tracing system according to the first embodiment and the description of elements similar to those of the first embodiment will be omitted.

A tracer generation and registration part 11 of a trace center apparatus 1 embeds in a tracer a predetermined character string that indicates that the tracer is not malware. The predetermined character string indicating that a tracer is not malware is a so-called content signature.

The predetermined character string that indicates a tracer is not malware may be inserted in the code of the tracer, for example. The character string may include numerics and symbols.

Assume here that information about the predetermined character string indicting that a tracer is not malware is taken into antivirus software. Also assume that the antivirus software is set or installed on a different computer 3.

When antivirus software on the different computer 3 detects the predetermined character string, the antivirus software regards the tracer including the predetermined character string as non-malware and excludes the tracer from virus removal.

Embedding a predetermined character string that indicates that a tracer is not malware in the tracer in this way can prevent a tracer-containing content from being removed by antivirus software.

### Fourth Embodiment

A leaked information tracing system according to a fourth embodiment differs from the leaked information tracing system according to the first to third embodiments in that an information receiving part 12 receives a file access log on a different computer 3 from the computer 3. The other elements are similar to those of the leaked information tracing systems according to the first to third embodiments.

An example of the fourth embodiment will be described in which the information receiving part 12 of the leaked information tracing system of the first embodiment receives a file access log on a different computer 3 from the different computer 3. The following description will focus on differences from the leaked information tracing system according to the first embodiment and the description of elements similar to those of the leaked information tracing system of the first embodiment will be omitted.

The information receiving part 12 receives a file access log kept on a different computer 3. The file access log is information concerning file access, such as the name of a file accessed, a person who accessed, access date and time and, if a file accessed has been edited and saved, the name of the saved file, the person who saved the file, and save date and time.

If the network 4 is a corporate LAN, for example, access monitoring software can be installed in the different computer 3 in advance. In that case, a file access log on the different computer 3 is generated by the access monitoring software installed on the different computer 3. In that case, the information receiving part 12 receives the file access log generated by the access monitoring software.

If a leaked tracer-containing content is edited and becomes a different file, the tracer may or may not function depending on the type and degree of the edit. If the tracer functions, the tracer can continue tracing the leaked content; if the tracer does not function, tracing cannot be performed by the tracer and therefore another means needs to be used. The access monitoring software residing on the different computer 3 generates a file access log and sends the file access log to the information receiving part 12 as described above, so that leaked information can be traced to a leak recipient within the range where the access monitoring software can function, even if the tracer no longer functions because of editing and modification. The access monitoring software may be sometimes also referred to as an access log acquiring program.

Note that the tracer generation and registration part 11 may include access monitoring software in a tracer when adding the tracer to a content. In that case, the tracer in the content generates a file access log on the different computer 3. The information receiving part 12 receives the file access log generated by the access monitoring software included in the tracer.

Note that the information receiving part 12 may analyze the file access log received from the tracer to estimate whether or not there is a file resulting from editing a tracer-containing content. In other words, the information receiving part 12 may analyze the access log to estimate whether or not there is an edited and modified file of the content.

For example, assume that a tracer-containing content X was edited and saved as a content Y on the different computer 3. In that case, the access monitoring software generates a file access log including the name of a person who accessed the tracer-containing content X, the date and time at which the tracer-containing content X was accessed, and the name of a person who saved the content Y, and the date and time at which the content Y was saved, and sends the file access log to the information receiving part 12.

The information receiving part 12 analyzes the received file access log to estimate whether or not the content Y is an edited version of the tracer-containing content X. If the name of the person who accessed the tracer-containing content X is the same as the name of the person who saved the content Y and the content Y was saved within a predetermined period of time after the time of access to the tracer-containing content X, the information receiving part 12 determines that the content Y is an edited version of the tracer-containing content X. In that case, the information receiving part 12 sends an indication that the content Y is an edited version of the tracer-containing content X to the user's computer 2.

In this way, the information receiving part 12 receives a file access log, thereby enhancing the possibility of successful tracing of a tracer-containing content even if the content was edited.

Note that instead of the information receiving part 12, the tracer on the different computer 3 may analyze the access log to estimate whether or not there is an edited and modified file of the content. In that case, the tracer sends the result of estimation as to whether there is an edited and modified file from the different computer 3 to the trace center apparatus 1.

[Modifications]

Any of the leaked information tracing system according to the first to fourth embodiments may include at least one of a trace center apparatus 1, a user's computer 2, a different computer 3, and an antivirus center apparatus 5.

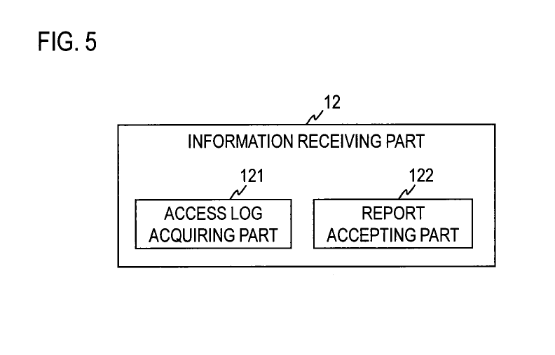

As illustrated in FIG. 5, an information receiving part 12 may include an access log acquiring part 121 which receives access log information and a report accepting part 122 which accepts identification information of a tracer and information about a different computer 3. Estimation based on analysis of an access log as to whether there is an edited and modified file of the content may be made by the access log acquiring part 121 or may be made by the report accepting part 122.

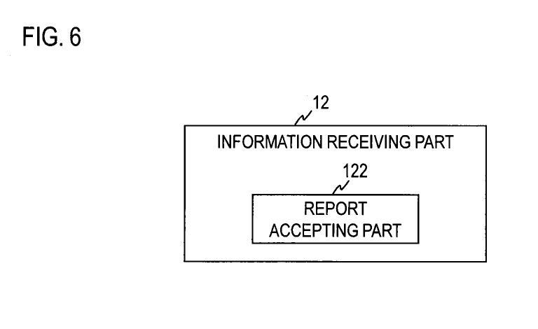

Note that the information receiving part 12 may include only the report accepting part 122 as illustrated in FIG. 6. In that case, the report accepting part 122 has the function of the access log acquiring part 121 described above.

While opening a tracer-containing content triggers the tracer to send identification information of the tracer and information about the different computer 3 to the trace center apparatus 1 in the embodiments described above, the identification information of the tracer and information about the different computer 3 may be sent from the computer 3 to the trace center apparatus 1 at regular intervals.

A tracer may store at least one of the identification information of the tracer, information about the different computer 3, and the file access log in a storage, not depicted, of the different computer 3. In that case, the tracer sends at least one of the identification information of the tracer, information about the different computer 3 and the file access log, that are retrieved from the storage, to the information receiving part 12.

A tracer may encrypt and store at least one of the identification information of the tracer, information about the different computer 3, and the file access log in a storage, not depicted, of the different computer 3. In that case, the tracer sends at least one of the identification information, the information about the different computer 3 and the file access log, that are retrieved from the storage, to the information receiving part 12 without decrypting the information or may decrypt the information and send the decrypted information to the information receiving part 12.

A tracer may be triggered by copying of the tracer-containing content to send the identification information of the tracer and information about the computer on which the content has been copied to the information receiving part 12. In that case, when the tracer-containing content is copied, the information receiving part 12 receives from the tracer the identification information of the tracer and information about the computer on which the content has been copied.

If a content is copied on the same computer, information about the computer on which the content has been copied is information about the same computer. If a content is copied from computer A to computer B, the information about the computer on which the content has been copied is information about at least one of computers A and B.

If there is a file access log, of course a tracer may send the file access log in addition to the identification information of the tracer and information about the computer on which the content has been copied.

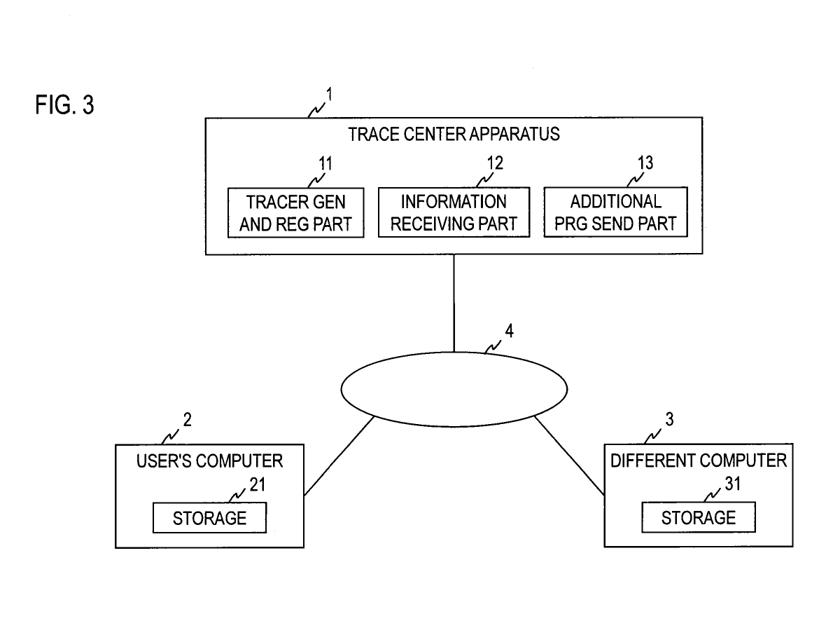

The trace center apparatus 1 may further include an additional program sending part 13 which sends an additional program to be embedded in a tracer in a tracer-containing content. Examples of the additional programs include the access monitoring software described in the fourth embodiment. FIG. 3 is a block diagram of a leaked information tracing system where the additional program sending part 13 is provided in the trace center apparatus 1 of the first embodiment.

The provision of the additional program sending part 13 enables a desired function to be added to a tracer afterward so that more desirable tracing can be performed.

In order to decide on an additional program to send, a tracer may acquire information about the system environment of a different computer 3 and may send the information to the trace center apparatus 1. In that case, the additional program sending part 13 chooses the type of an additional program to send to the tracer in accordance with the received system environment of the different computer 3 and sends the chosen additional program.

The information receiving part 12 may store information received from the different computer 3, such as a network address such as an IP address or MAC address, or UUID of the different computer 3 and a file access log on the different computer 3 in a storage, not depicted, in the trace center apparatus 1 with or without encryption.

Note that a tracer-containing content can be generated on a user's computer 2. In that case, the tracer generation and registration part 11 of the trace center apparatus 1 sends a generated tracer to the user's computer 2. The user's computer 2 receives the tracer and adds the tracer to a content to generate a tracer-containing content.

Each of the trace center apparatus 1, the user's computer 2, the different computer 3 and the antivirus center apparatus 5 may be implemented by a computer. In that case, the processes performed by each parts of these apparatuses are described in a program. The program is executed on the computer to implement the parts of the apparatus on the computer.

A program for causing a computer to function as each means of the trace center apparatus 1 or a program for causing processes of the trace center apparatus 1 to be executed may be sometime referred to as a trace center program. A program for causing a computer to function as the means of the different computer 3 or a program for causing a computer to function as the means of the trace center apparatus 1, or causing a computer to perform the processes of the trace center apparatus 1 may be sometimes referred to as a tracer program.

The program describing the processes may be recorded on a computer-readable recording medium. While a predetermined program is executed on a computer to configure each of these apparatuses in this mode, at least some of these processes may be implemented by hardware.

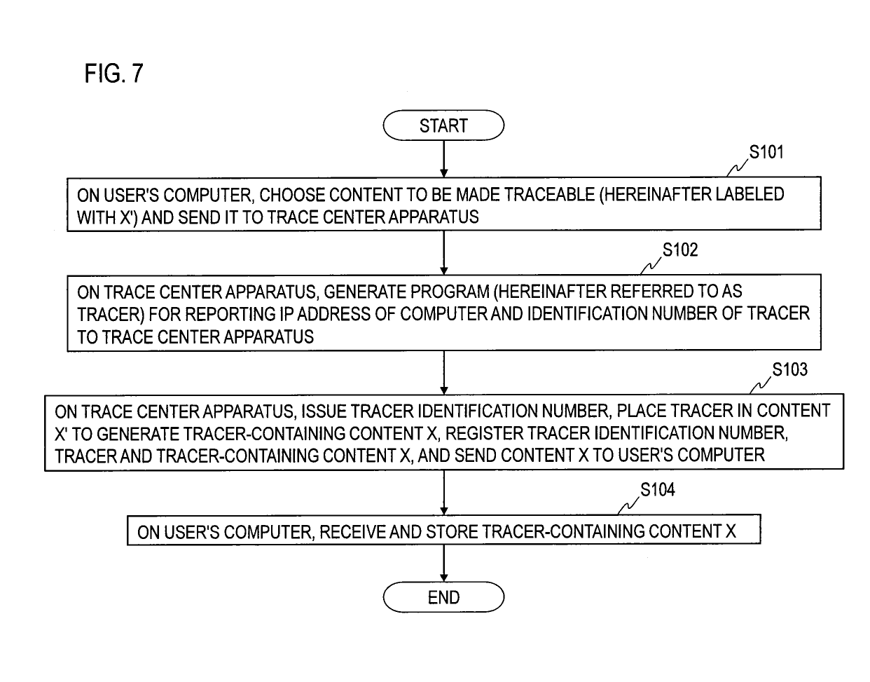

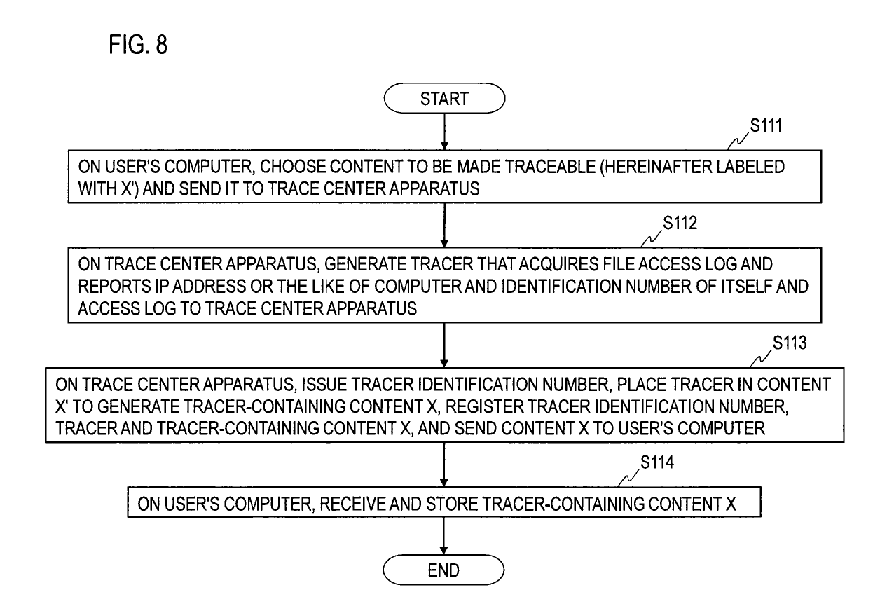

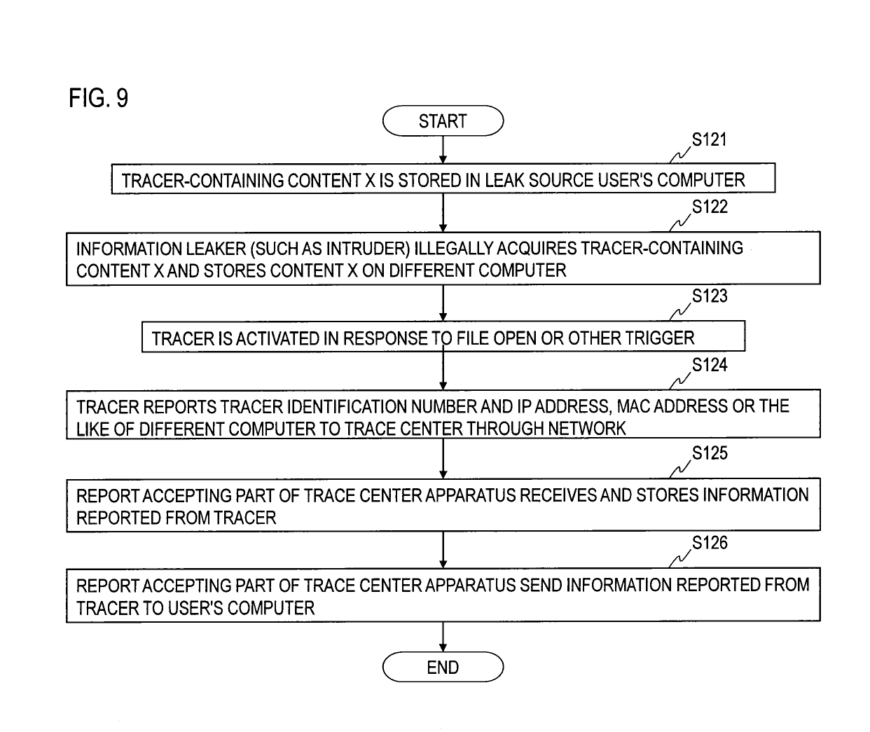

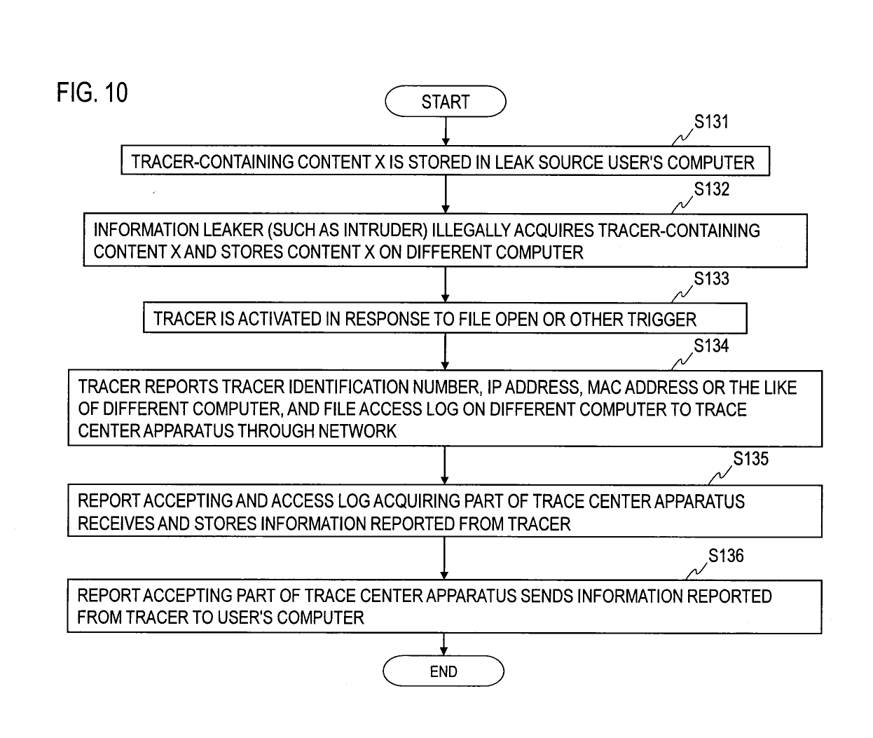

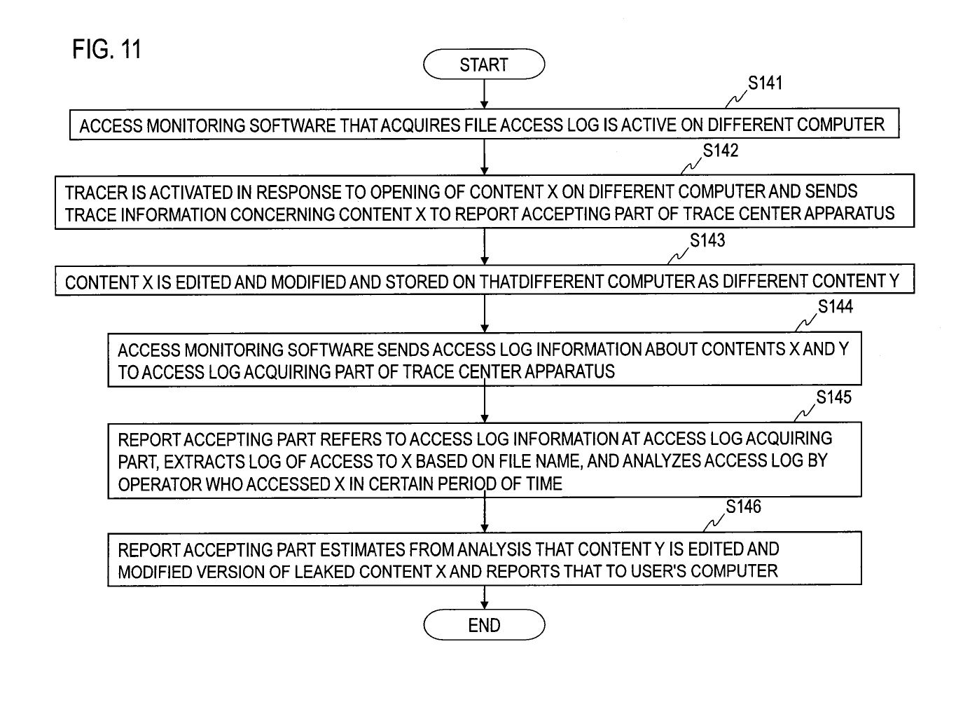

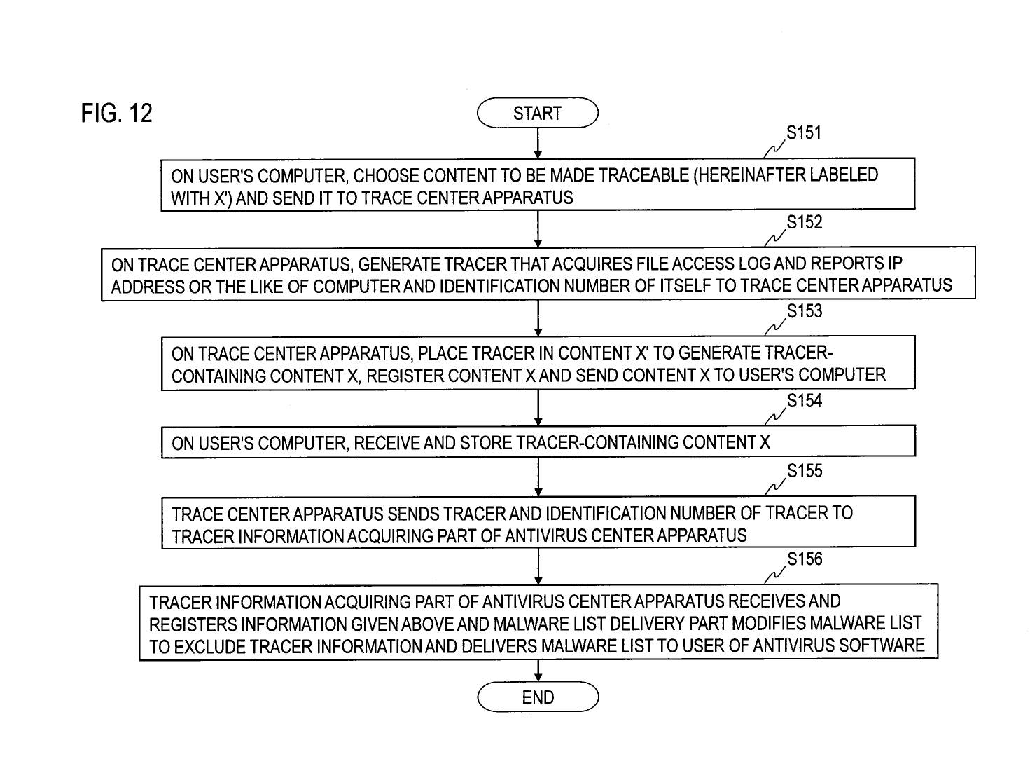

Examples of the processes performed by the leaked information tracing system can be summarized as illustrated in FIGS. 7 to 12.

The foregoing descriptions of embodiments given above can be summarized as follows.

A first leaked information tracing system includes a trace center apparatus including a tracer generation and registration part which adds a tracer to a content and sends the tracer-containing content including the added tracer to a user's computer and an information receiving part which, if the tracer-containing content is leaked from the user's computer to a different computer, receives identification information of the tracer and information about the different computer from the tracer of the leaked tracer-containing content.

A second leaked information tracing system is a leaked information tracing system in which the information receiving part of the first leaked information tracing system receives a file access log on the different computer from the different computer.

A third leaked information tracing system is a leaked information tracing system in which the information receiving part of the second leaked information tracing system analyzes the file access log to estimate whether or not there is a file that is an edited version of the tracer-containing content.

A fourth leaked information tracing system is any one of the first to third leaked information tracing systems which further includes a tracer information receiving part acquiring information about the tracer from the trace center apparatus and a malware list delivery part distributing a malware list excluding the tracer about which the information has been acquired.

A fifth leaked information tracing system is a leaked information tracing system in which the tracer generation and registration part of any one of the first to third leaked information tracing systems embeds a predetermined character string indicating that the tracer is non-malware in the tracer.

A sixth leaked information tracing system is a leaked information tracing system in which the tracer of any one of the first to fifth leaked information tracing systems stores on the different computer at least one of the identification information, the information about the different computer and the file access log.

A seventh leaked information tracing system is a leaked information tracing system in which the tracer of the sixth leaked information tracing system encrypts and stores on the different computer at least one of the identification information, the information about the different computer and the file access log.

An eighth leaked information tracing system is a leaked information tracing system in which the information receiving part of any one of the first to seventh leaked information tracing systems receives, when the tracer-containing content is copied, the identification information of the tracer and information about the computer on which the tracer-containing content has been copied from the tracer of the tracer-containing content.

A ninth leaked information tracing system is a leaked information tracing system in which the trace center apparatus of any one of the first to eighth leaked information tracing systems further includes an additional program sending part sending an additional program to be embedded in the tracer of the tracer-containing content.

A leaked information tracing method includes a tracer generation and registration step of a tracer generation and registration part adding a tracer to a content and sending the tracer-containing content including the added tracer to a user's computer and an information receiving step of, if the tracer-containing content is leaked from the user's computer to a different computer, an information receiving part receiving identification information of the tracer and information about the different computer from the tracer of the leaked tracer-containing content.

A leaked information tracing program is a program for causing a computer to function as parts of any one of the first to ninth leaked information tracing systems.

### Fifth Embodiment

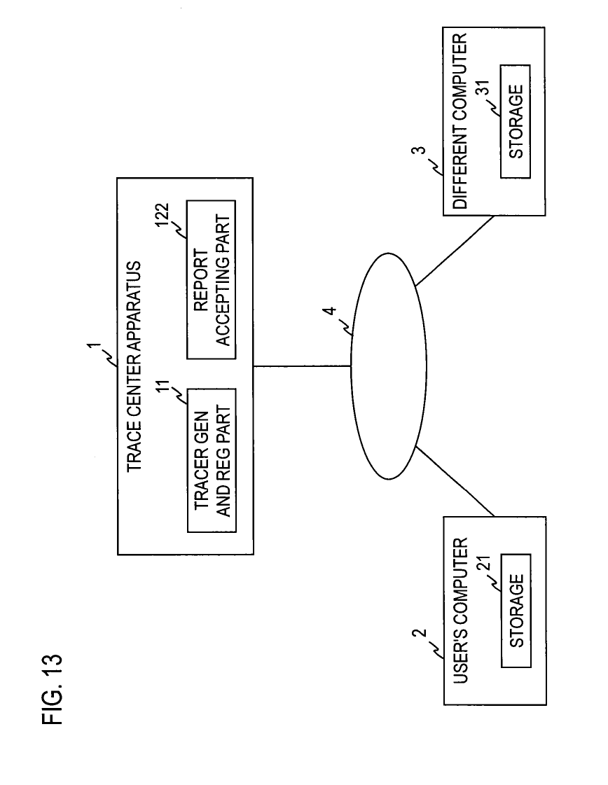

A leaked information tracing system according to a fifth embodiment includes a trace center apparatus 1, for example, as illustrated in FIG. 13. A user's computer 2 and a different computer 3 are connected to the trace center apparatus 1 through a network 4 such as the Internet or a LAN (Local Area Network).

The trace center apparatus 1 includes a tracer generation and registration part 11 and a report accepting part 122, for example, as illustrated in FIG. 13.

The tracer generation and registration part 11 of the trace center apparatus 1 receives a content to be traced if the content is leaked and adds a tracer to the received content to generate a tracer-containing content. The tracer-containing content is provided to the user's computer 2.

The tracer is a program that if a content is leaked, sends identification information of the tracer and information about a leak recipient computer from the leak recipient computer to the trace center apparatus 1 as will be described later. Furthermore, the tracer is a program in an executable format that prevents access to a content to which the tracer is added unless certain preprocessing is executed. The certain preprocessing is processing that is generally needed for a user to access a content, such as self-extract processing, decryption of an encrypted content, processing for acquiring the right to use a content, or user authentication processing. A tracer may be sometime also referred to as a tracing function or a tracer program.

When the tracer generation and registration part 11 generates a tracer, the tracer generation and registration part 11 may issue identification information for the tracer or the tracing function and may include the identification information in the tracer. In that case, the tracer including the identification information is added to a content. Note that the identification information may be an identification number. For example, the identification information of the tracer is a tracer identification number that can uniquely identify a content that resides on the user's computer 2 and can also uniquely identify the tracer. The tracer generation and registration part 11 may register at least one of a generated tracer, a tracer-containing content, and a file name of the tracer-containing content.

A tracer-containing content may be sometimes referred to as a reconstructed content.

The tracer generation and registration part 11 receives a content that is to be traced if the content is leaked from the user's computer 2 through the network 4, for example.

Similarly, the tracer generation and registration part 11 sends a tracer-containing content to the user's computer 2 through the network 4, for example, to provide the tracer-containing content to the user's computer 2.

The tracer-containing content received from the tracer generation and registration part 11 is stored in a storage 21 of the user's computer 2.

Note that the tracer generation and registration part 11 may generate and register a tracer and send the tracer to the user's computer 2 so that the user's computer 2 generates a tracer-containing content. In that case, the user's computer 2 receives the tracer from the trace center apparatus 1, includes the tracer into a content to generate a tracer-containing content, and stores the tracer-containing content in the storage 21.

Assume here that a tracer-containing content is leaked from the user's computer 2 and stored in a storage 31 of a different computer 3. For example, a tracer-containing content can be leaked from the user's computer 2 to a different computer 3 by an intruder through unauthorized access to the user's computer 2.

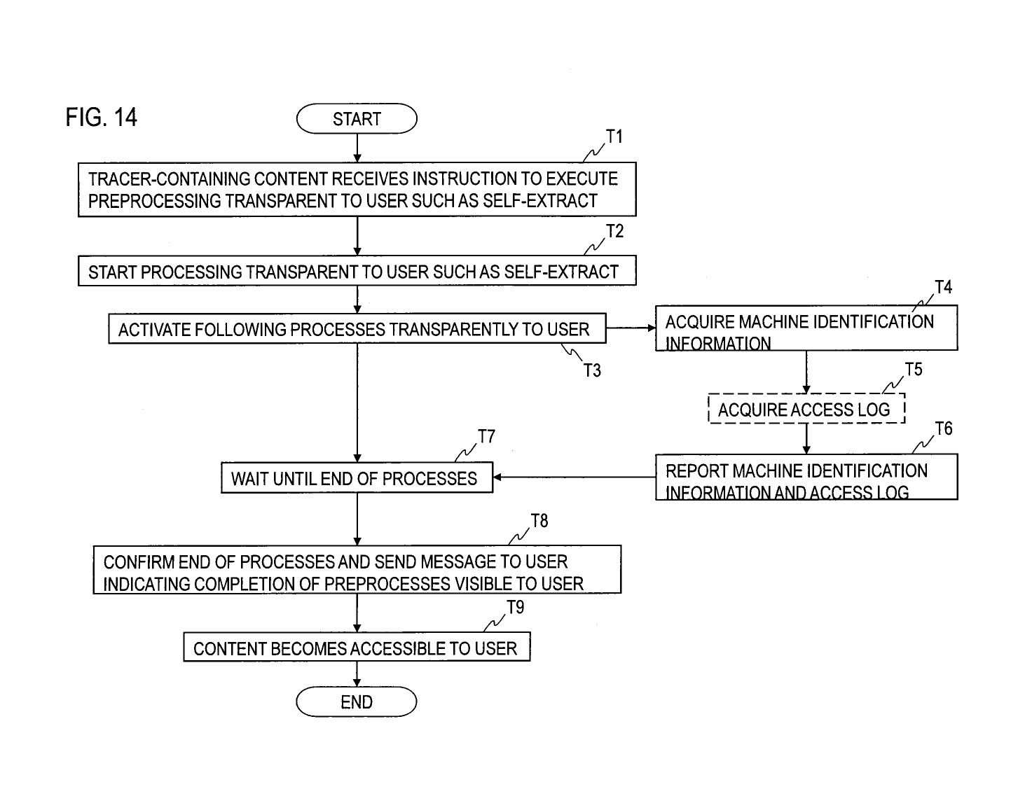

The tracer-containing content performs a process illustrated in FIG. 14, for example, on the different computer 3. FIG. 14 is a diagram illustrating an example of a program processing structure for a tracer-containing content.

When the tracer-containing content receives an instruction to execute certain processing, such as self-extract, that is transparent to the user (step T1), the tracer initiates the certain processing transparent to the user (step T2). Specifically, the process from step T4 to step T6 is performed transparently to the user (step T3). First, the tracer acquires information about the different computer 3 (step T4). The tracer then reports the acquired information about the different computer 3 to the trace center apparatus 1 (step T6). Of course, the tracer may send identification information of the tracer to the trace center apparatus 1 along with the information about the different computer 3 at step T6. After waiting for completion of the process from step T4 to step T6 (step T7) and confirming the end of the process from step T4 to step T6, the tracer provides a notification of the completion of the certain preprocessing to the user of the different computer 3 (step T8). Then the tracer-containing content becomes accessible to the user.

The report accepting part 122 of the trace center apparatus 1 receives the report from the tracer, i.e. information about the different computer. If the tracer has sent identification information of the tracer, the report accepting part 122 receives the identification information of the tracer as well.

Information about the different computer 3 is identification information of the different computer 3 such as an IP address, MAC address or UUID, for example, of the different computer 3. If the different computer 3 is a mobile phone, the information about the different computer 3 may be an individual identification number of the mobile phone.

The report accepting part 122 notifies the user computer 2 of the information leakage. In doing this, the report accepting part 122 may send all or part of information acquired from the tracer to the user's computer 2 as necessary.

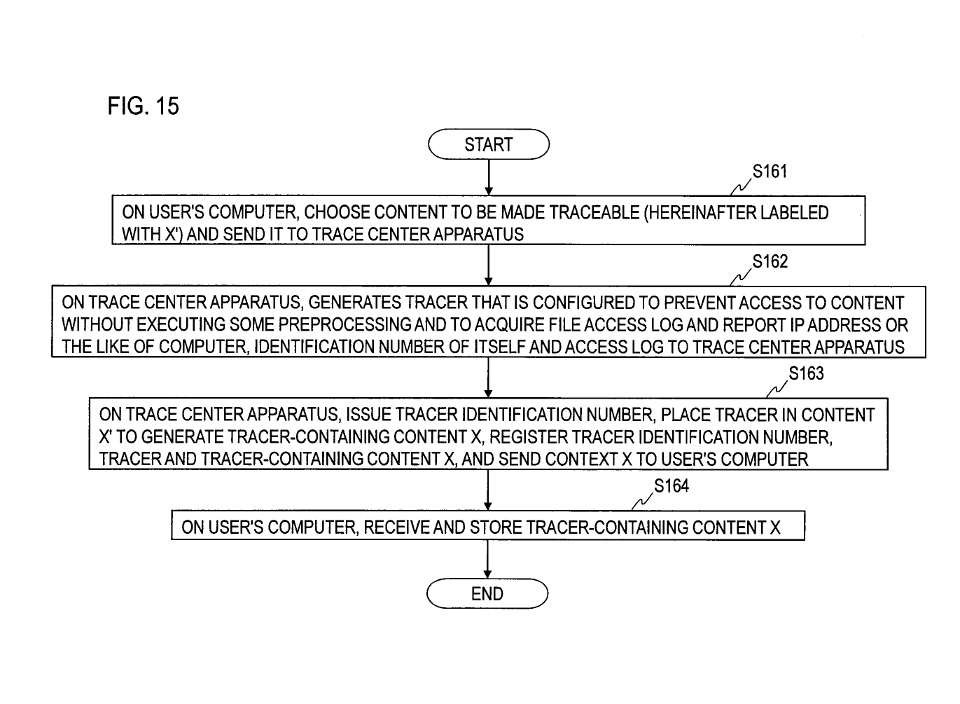

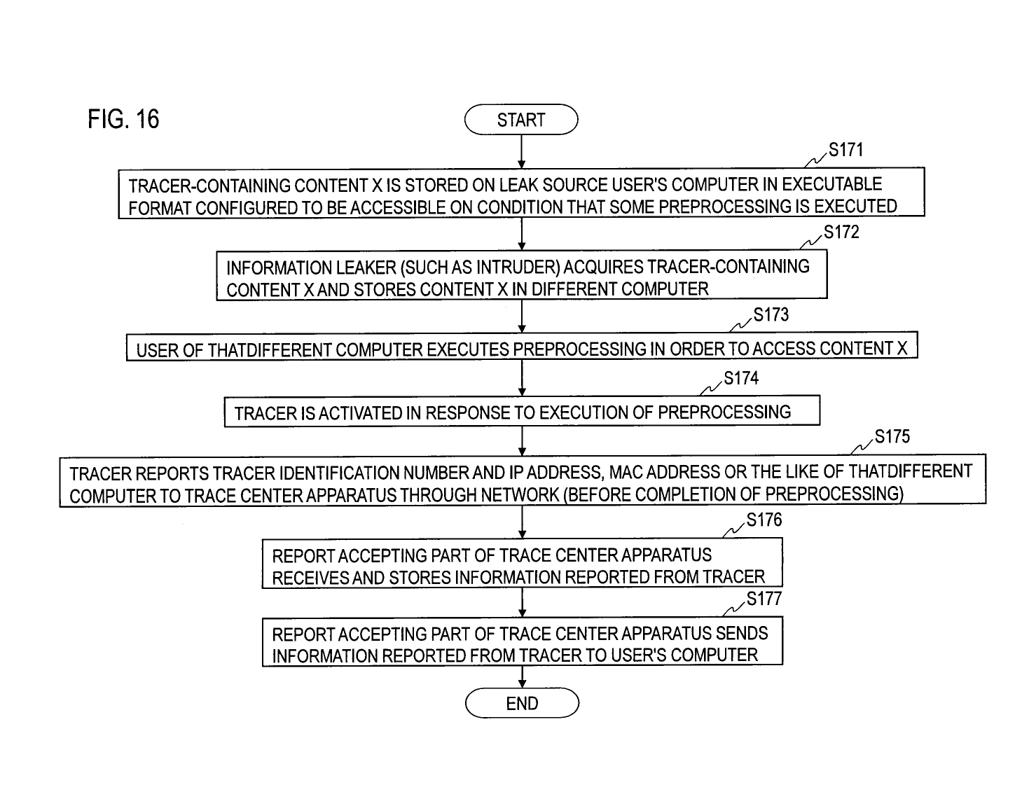

The flow of the process performed in the leaked information tracing system according to the fifth embodiment described above can be summarized as illustrated in FIGS. 15 and 16.

If a content is leaked, the leakage can be reported during certain processing that is transparent to the user in this way to send information indicating the location of the content itself and to prevent the informing function from being inhibited by an operation on the leak recipient computer. In other words, the leak recipient can be identified and tracing can be prevented from being inhibited.

### Sixth Embodiment

A leaked information tracing system according to a sixth embodiment differs from the leaked information tracing system according to the fifth embodiment in that a report accepting part 122 receives a file access log kept on a different computer 3 from the different computer 3. The rest of the leaked information tracing system is similar to the leaked information tracing system according to the fifth embodiment. The following description will focus on the difference from the leaked information tracing system according to the fifth embodiment and the description of the elements similar to those of the leaked information tracing system according to the fifth embodiment will be omitted.

The report accepting part 122 receives a file access log kept on a different computer 3. The file access log is information about file access such as the name of a file accessed, the person who accessed the file, access time and, if the accessed file was edited and stored, the name of the file stored, the person who stored the file, and store time.

If the network 4 is a corporate LAN, for example, access monitoring software can be installed in different computers 3 beforehand. In that case, a file access log on a different computer 3 is generated by the access monitoring software installed on the different computer 3. The report accepting part 122 receives the file access log generated by the access monitoring software.

If a leaked tracer-containing content is edited and becomes a different file, the tracer may or may not function depending on the type and degree of the edit. If the tracer functions, the tracer can continue tracing the leaked content; if the tracer does not function, tracing cannot be performed by the tracer and therefore another means needs to be used. The access monitoring software residing on the different computer 3 generates a file access log and sends the file access log to the information receiving part 12 as described above, so that leaked information can be traced to a leak recipient within the range where the access monitoring software can function, even if the trace no longer function due to editing and modification.

Note that the tracer generation and registration part 11 may include the access monitoring software in a tracer when adding the tracer to a content. In that case, the tracer of the tracer-containing content generates a file access log on the different computer 3. The access monitoring software in the tracer further performs the process for acquiring the access log at step T5 of FIG. 14 and the information receiving part 122 receives the file access log generated by the access monitoring software included in the tracer.

Note that the information receiving part 12 may analyze the file access log received from the tracer to estimate whether or not there is a file resulting from editing a tracer-containing content. In other words, the information receiving part 122 may analyze the access log to estimate whether or not there is an edited and modified file of the content.

For example, assume that a tracer-containing content X was edited and saved as a content Y on the different computer 3. In that case, the access monitoring software generates a file access log including information such as the name of a person who accessed the tracer-containing content X, the date and time at which the tracer-containing content X was accessed, and the name of a person who saved content Y, and the date and time at which the content Y was saved, and sends the file access log to the information receiving part 122.

The information receiving part 122 analyzes the received file access log to estimate whether or not the content Y is an edited version of the tracer-containing content X. If the name of the person who accessed the tracer-containing content X is the same as the name of the person who saved the content Y and the content Y was saved within a predetermined period of time after the time of access to the tracer-containing content X, the information receiving part 122 determines that the content Y is an edited version of the tracer-containing content X. In that case, the information receiving part 122 sends an indication that the content Y is an edited version of the tracer-containing content X to the user's computer 2.

In this way, the information receiving part 122 receives a file access log, thereby enhancing the possibility of successful tracing of a tracer-containing content even if the content was edited.

[Modifications]

While opening a tracer-containing content triggers the tracer to send identification information of the tracer and information about the different computer 3 to the trace center apparatus 1 in the fifth and sixth embodiments described above, at least one of the identification information of the tracer, information about the different computer 3, and an access log may be sent from the computer 3 to the trace center apparatus 1 at regular intervals.

As for the tracing function, if an identification number of a leak recipient computer meets a certain condition, the subprogram of the tracing function may be configured to be aborted after reporting the identification information of the computer, or may be configured to be aborted without performing anything. For example, a certain condition may be set for a field where a country is specified in an IP address.

A tracer may store at least one of the identification information of the tracer, information about the different computer 3, and the file access log in a storage, not depicted, of the different computer 3. In that case, the tracer sends at least one of the identification information of the tracer, information about the different computer 3 and the file access log, that are retrieved from the storage, to the trace center apparatus 1.

A tracer may encrypt and store at least one of the identification information of the tracer, information about the different computer 3, and the file access log in a storage, not depicted, of the different computer 3. In that case, the tracer sends at least one of the identification information, the information about the different computer 3 and the file access log, that are retrieved from the storage, to the trace center apparatus 1 without decrypting the information or may decrypt the information and send the decrypted information to the trace center apparatus 1.

A tracer may be triggered by copying of the tracer-containing content to send the identification information of the tracer and information about the computer on which the content has been copied to the trace center apparatus 1. In that case, when the tracer-containing content is copied, the trace center apparatus 1 receives from the tracer the identification information of the tracer and information about the computer on which the content has been copied.

If a content is copied on the same computer, information about the computer on which the content has been copied is information about the same computer. If a content is copied from computer A to computer B, the information about the computer on which the content has been copied is information about at least one of computers A and B.

If there is a file access log, of course a tracer may send the file access log in addition to the identification information of the tracer and information about the computer on which the content has been copied.

After the tracer receives an instruction to execute certain processing, such as self-extract, that is transparent to the user (step T1), the tracer may display a screen page that informs the user of the different computer 3 that a process for acquiring identification information of the different computer 3 and reporting the identification information to the trace center apparatus 1 will be executed and allows the user to choose whether to approve or disapprove the reporting. In that case, if the user approves the reporting, the tracer executes the process from step T2 to step T8. If the user chooses to disapprove on the screen for choosing whether or not to approve the reporting, no further processing is performed and the user cannot access the content.

Furthermore, the tracer may be configured to cause a user attempt to save the content on the different computer 3 to fail after the content becomes accessible to the user of the different computer 3.

Each of the trace center apparatus 1, the user's computer 2 and the different computer 3 may be implemented by a computer. In that case, the processes performed by each parts of these apparatuses are described in a program. The program is executed on the computer to implement the parts of the apparatus on the computer.

The program describing the processes may be recorded on a computer-readable recording medium. While a predetermined program is executed on a computer to configure each of these apparatuses in this mode, at least some of these processes may be implemented by hardware.

### Seventh Embodiment

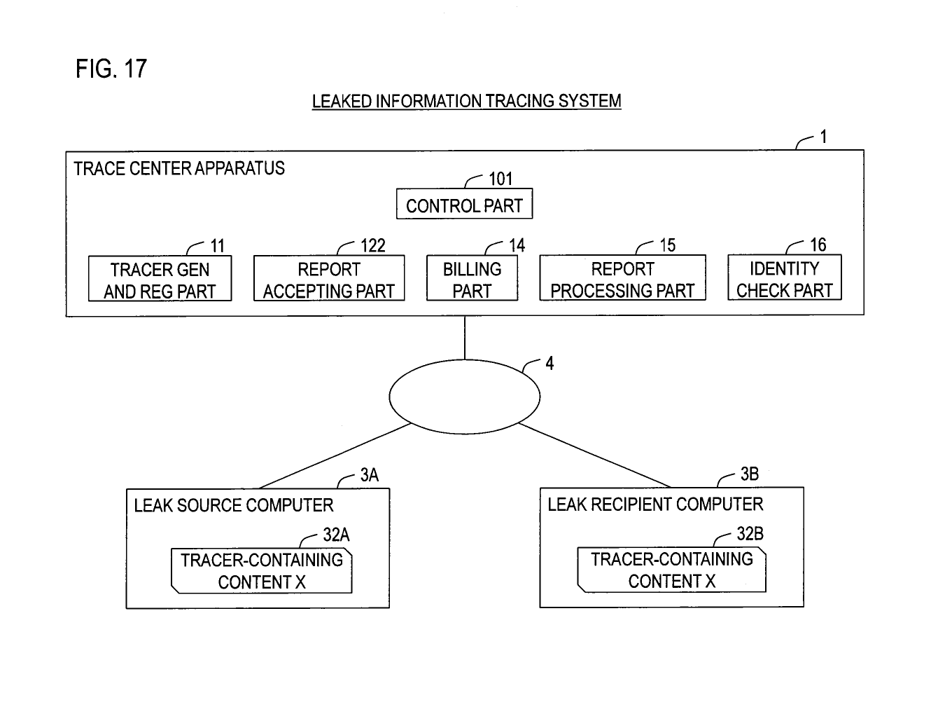

FIG. 17 is a diagram illustrating a configuration of a leaked information tracing system according to a seventh embodiment. The leaked information tracing system includes a trace center apparatus 1 and computers 3A and 3B. The trace center apparatus 1 and the computers 3A and 3B are connected to a network 4 such as the Internet or a LAN. The trace center apparatus 1 includes a control part 101, a tracer generation and registration part 11, a report accepting part 122, a billing part 14, a report processing part 15 and an identity check part 16. The trace center apparatus 1 executes processes under the control of the control part 101. The computer 3A is a leak source computer and the computer 3B is a leak recipient computer. It is assumed here that tracer-containing contents X (32A, 32B) are stored on the computers 3A and 3B. Although information leakage does not necessarily occur on the computers 3A, 3B, it is assumed in the following description that the computer 3A is a leak source computer and the computer 3B is a leak recipient computer, for illustrating how the leaked information tracing system works in the event of leakage.

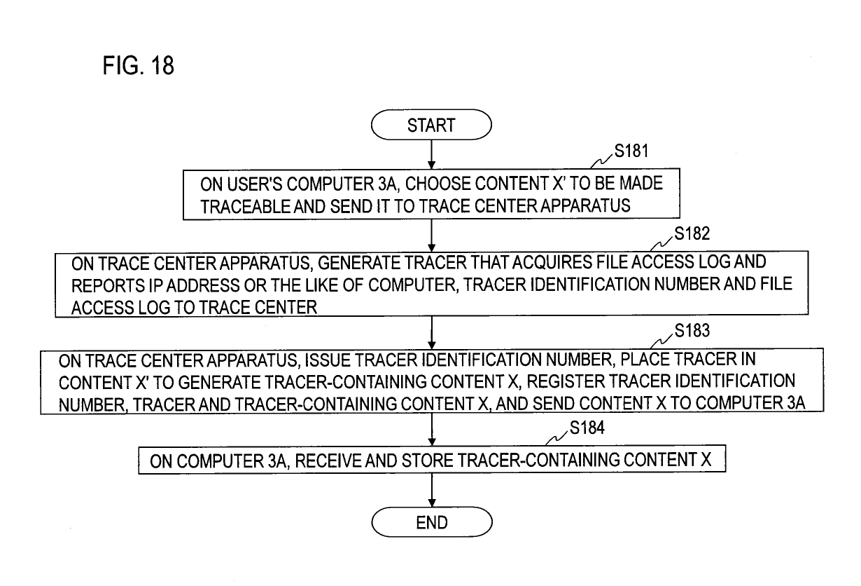

Referring to FIG. 18, a procedure for generating and registering a tracer-containing content will be described. A content to be made traceable (hereinafter referred to as the content X′) is stored on the computer 3A. When the computer 3A sends the content X′ to the trace center apparatus 1 (step S181), the tracer generation and registration part 11 provided in the trace center apparatus 1 first generates a program (hereinafter referred to as the tracer) that reports computer identification information which is an IP address or the like of a leak recipient computer 3B and tracer identification information which is an identification number of the tracer (step S182). The tracer registration and registration part 11 issues a tracer identification number, includes the tracer in the content X′ to generate a tracer-containing content X, registers the tracer identification number, the tracer, the tracer-containing content X, and the file name of the tracer-containing content X, and then sends the tracer-containing content X to the computer 3A (step S183). The computer 3A receives the tracer-containing content X and saves the tracer-containing content X, and the file of the tracer-containing content X becomes accessible (step S184).

When the tracer is configured at step S182, the tracer may be configured to have an access monitoring function for acquiring a log of access to files. An access acquiring part 121 (not depicted) which receives a file access log may be provided in the trace center apparatus 1. The report accepting part 122 and the access log acquiring part 121 may be combined together into an information receiving part 12 (not depicted). Furthermore, the tracer may be configured to have the function of encrypting information including identification number of the tracer, time, and file access log information on a leak recipient computer 3B and storing the encrypted information on the leak recipient computer 3B.

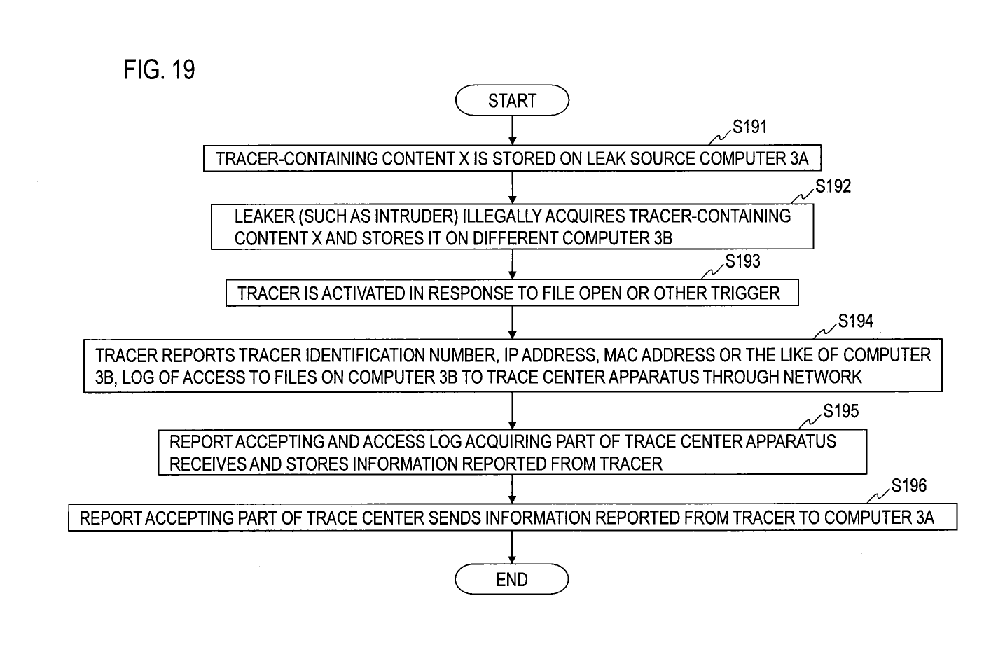

A procedure for the tracing function to report information leakage will be described with reference to FIG. 19. It is assumed here that when a file of a tracer-containing content X saved on the leak source computer 3A is accessible (step S191), an information leaker (such as an intruder) illegally acquires the tracer-containing content X and stores the content X on a different computer B (step S192). Then, the tracer in the content X is activated in response to a file open or the like (step S193). The tracer reports a tracer identification number and computer identification information such as an IP address or MAC address of the computer 3B to the trace center apparatus 1 through a network (step S194). The report accepting part 122 of the trace center apparatus 1 receives and saves the information reported from the tracer (step S195) and then the report accepting part 122 of the trace center apparatus 1 sends the information reported from the tracer to the leak source computer 3A (step S196).

When the tracer-containing content X leaked is edited and modified and becomes a different file, the tracer may or may not function depending on the type or degree of editing and modification. If the tracer functions, tracing of the leaked information can be continued. However, if the tracer does not function, tracing cannot be continued by the tracer and therefore another means needs to be used. In order that a log of access to files can be acquired, a system is configured in which access monitoring software resides on the computer 3B, the access log acquiring part 121 (not depicted) is provided in the trace center apparatus 1, and the access monitoring software can communicate with the access log acquiring part 121. The configuration enables leaked information to be traced within a range where the access monitoring software functions even if the tracer no longer functions due to editing and modification.

The tracer is activated in response to opening the tracer-containing content X on the computer 3B for editing and modifying the content X and sends computer identification information such as the IP address or MAC address of the computer on which the content X resides and tracer identification information to the report accepting part 122 of the trace center apparatus 1. When the content X is edited, modified and saved on the computer 3B as a different content Y, the resident access monitoring software sends access log information indicating that the context X has been edited, modified and saved as the content Y to the access log acquiring part 121 of the trace center apparatus 1. The access log information includes information such as the file name of the tracer-containing content X, the date and time at which the file of the content X was opened, the operator who opened the file, the file name of the edited and modified content Y, the date and time at which the content Y was stored as a new file, and the operator who saved the content Y.

The report accepting part 122 refers to the access log information in the access log acquiring part 121 at regular intervals, extracts a log of access to the content X from the file names, and extracts the log of access by the operator who accessed the content X within a predetermined period of time after the time of access to the content X, thereby determining whether the operator who accessed the content X saved the content Y as a new file within the predetermined period of time. These facts are analyzed to estimate that the content Y is an edited version of the leaked content X, that is, estimate whether there is an edited version of the content X, and the result is reported to the computer 3A.

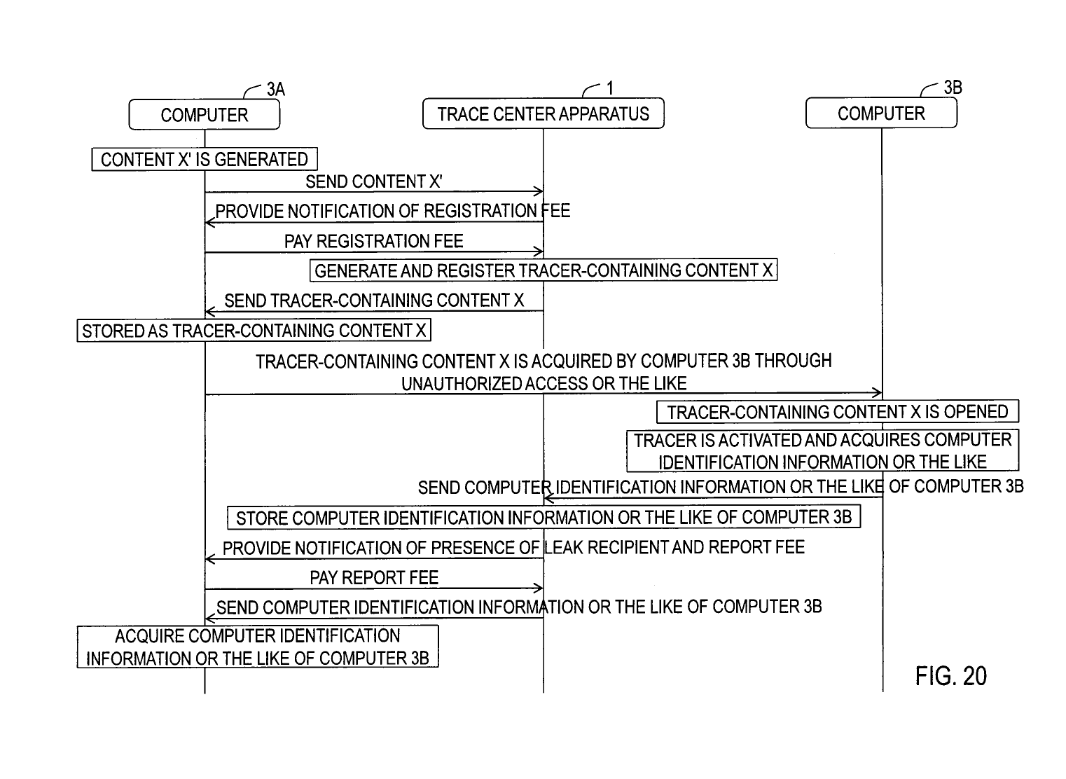

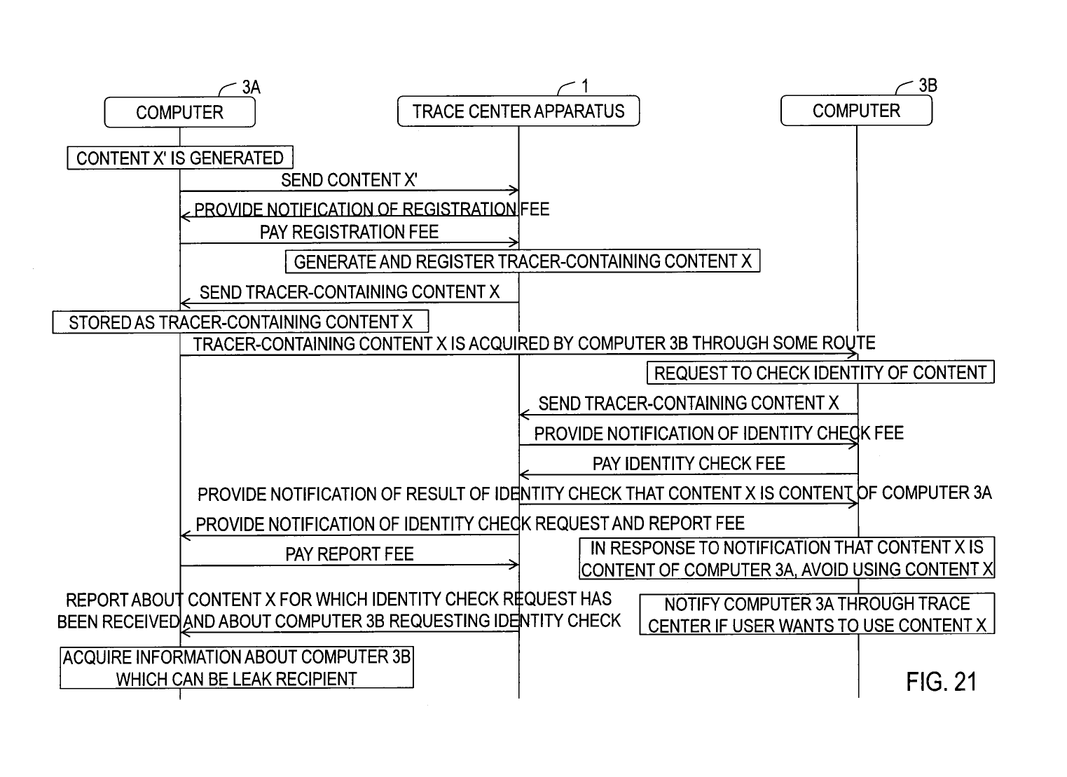

Division of roles in tracing transactions, including a billing transaction, among players will be described in conjunction with procedures for exchanging information among players and a billing process performed among the players illustrated in FIGS. 20 and 21. FIG. 20 illustrates an example of a process flow for billing for registration of a content X′ in the trace center apparatus 1 and billing for reporting a leakage of a content X to computer 3B to computer 3A.

When the content X′ generated on the computer 3A, which is an information source, is sent from the computer 3A to the trace center apparatus 1, the trace center apparatus 1 provides a notification of a registration fee to the computer 3A. When the registration fee is paid from the computer 3A to the trace center apparatus 1, a tracer-containing content X, which is the content X′ with the tracing function, is generated and registered in the trace center apparatus 1, and is then sent to the information source computer 3A, where the tracer-containing content X is stored.

Assume that the tracer-containing content X on the information source computer 3A is subsequently acquired through unauthorized access and is stored on the computer 3B. When the tracing function is activated subsequently in response to opening of the content on the leak recipient computer 3B, the trace function collects information such as identification information of the computer 3B and provides the information to the trace center apparatus 1. The trace center apparatus 1 notifies the computer 3A, which is an information source, that a recipient of information leaked from the computer 3A has been found and also notifies the compute 3A of a report fee. When the report fee is paid from the computer 3A to the trace center apparatus 1, the trace center apparatus 1 reports information such as the identification information of the computer 3B, which is the leak recipient, to the information source computer 3A.

There may be a situation where a tracer-containing content X residing on the information source computer 3A is acquired through some route but the person who has acquired the content X is not malicious and wants to check the identity of the content X. FIG. 21 illustrates an example of a process flow in such a situation.

If the user of the computer 3B wants to check the identity of the content X obtained through an unknown route, the user sends the content X from the computer 3B to the trace center apparatus 1. The trace center apparatus 1 notifies the computer 3B of an identity check fee. When the identity check fee is paid from the computer 3B to the trace center apparatus 1, the trace center apparatus 1 compares the content X received from the computer 3B with contents registered in the trace center apparatus 1. The trace center apparatus 1 finds a content identical or nearly identical to the content X and provides the result of the identity check to the computer 3B. It is assumed in this example that the content X received from the computer 3B is identical or nearly identical to a content X residing on the computer 3A. The trace center apparatus 1 notifies the information source computer 3A of the request for identity check and a report fee. When the report fee is paid from the computer 3A, the trace center apparatus 1 reports the result of the identity check to the computer 3A.

In order to implement the process flow of the tracing transactions including the billing process described above, the trace center apparatus 1 includes a billing part 14 which provides a notification of a registration fee, report fee, or an identity check fee mentioned above to the relevant computer 3A, 3B, and receives payment from the relevant computer 3A, 3B, a report processing part 15 which reports an identification number or the like of a leak recipient computer 3B to an information source computer 3A and reports a request for identity check for a content X that originated from the information source computer 3A to the information source computer 3A, and an identity check part 16 which, in response to a content identity check request made in order to identify the source of a content received through some route, compares the content X with contents registered in the trace center apparatus 1 and reports whether there is a content identical or nearly identical to the content X to the identity check requester.

### Eighth Embodiment

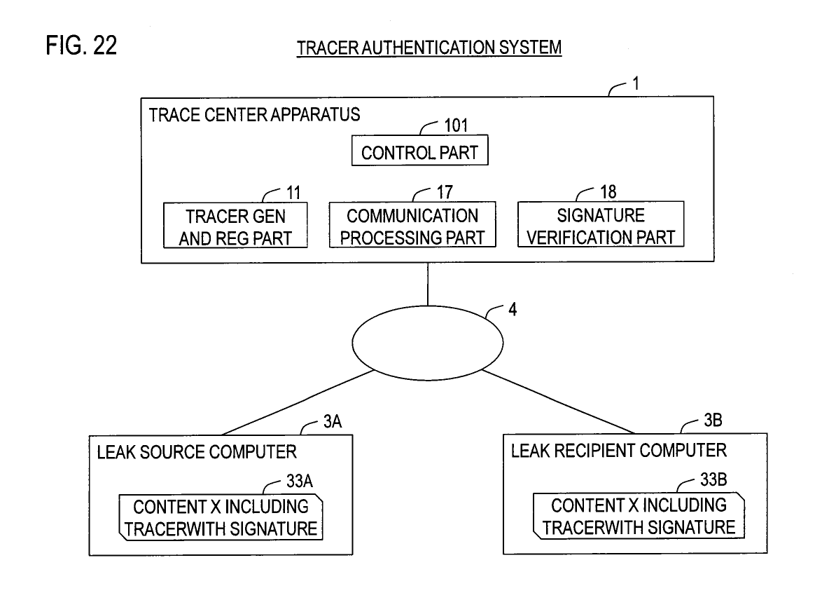

FIG. 22 is a diagram of a system configuration of a tracer authentication system according to an eighth embodiment. The tracer authentication system includes a trace center apparatus 1 and computers 3A, 3B. The trace center apparatus 1 and the computers 3A and 3B are connected to a network 4 such as the Internet or a LAN. The trace center apparatus 1 includes a control part 101, a tracer generation and registration part 11, a communication processing part 17 and a signature verification part 18. The trace center apparatus 1 executes processes under the control of the control part 101. The computer 3A is a leak source computer and the computer 3B is a leak recipient computer. It is assumed here that a content X (33A, 33B) including a tracer with a signature is stored in both of the computers 3A and 3B. Although information leakage does not necessarily occur on the computers 3A, 3B, it is assumed in the following description that the computer 3A is a leak source computer and the computer 3B is a leak recipient computer, for illustrating how the leaked information tracing system works in the event of leakage.

When the tracer generation and registration part 11 receives a content from a computer, the tracer generation and registration part 11 issues a tracer identification number, generates a tracer having the function of reporting identification information of a computer on which the content resides and a tracer identification number, adds an electronic signature to the tracer by using a secret key of the trace center apparatus 1, includes the tracer with the signature in the content, registers the content including the tracer with the signature, and sends the content including the tracer with the signature to the computer. The communication processing part 17 receives identification information of a different or the same computer acquired and sent by the tracer in a content activated together with a tracer identification number after the content including the tracer has been copied on the different or the same computer. The signature verification part 18 verifies the signature of a tracer with the signature by using a public key of the trace center apparatus 1 and sends the result of the verification to the tracer.

In the tracer generation and registration part 11, the tracer is configured to be activated before the body of the content is disclosed and is configured to ask to approve reporting of the identification information of a user's computer and the tracer identification number to the trace center apparatus 1 in order that the body of the content can be disclosed. If the user approves the reporting, the tracer sends the tracer with the signature to the trace center apparatus 1. The tracer is configured to disclose the body of the content to the user when the tracer receives an indication that the signature verification part 18 of the trace center apparatus 1 has verified that the signature of the tracer was added by the trace center apparatus 1. The tracer is configured in the tracer generation and registration part 11 so as not to disclose the body of the content to the user if the user does not approve reporting the identification information of the user's computer and the tracer identification number to the trace center apparatus 1 for disclosure of the body of the content.

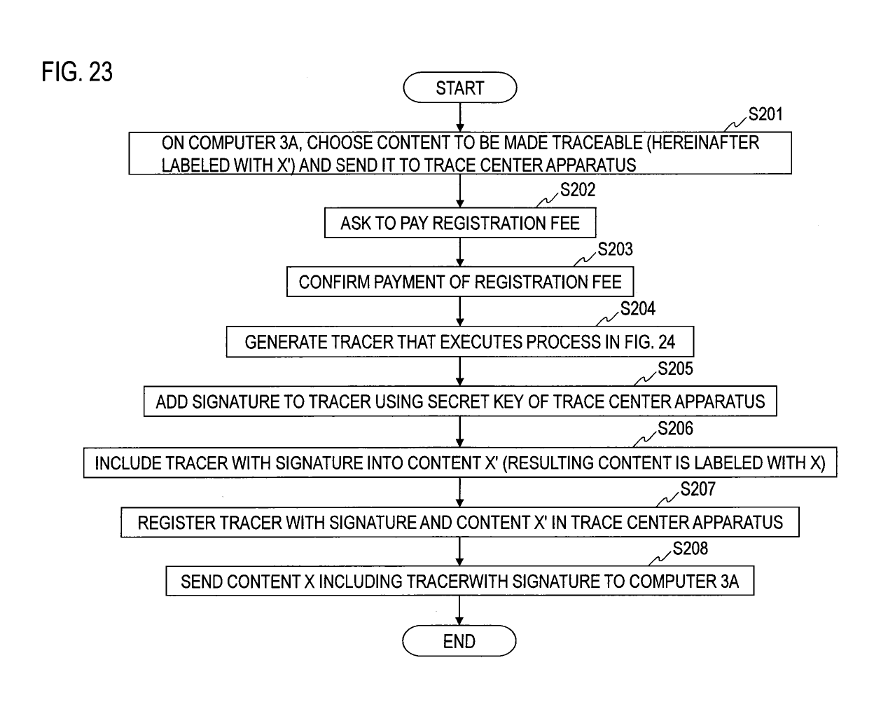

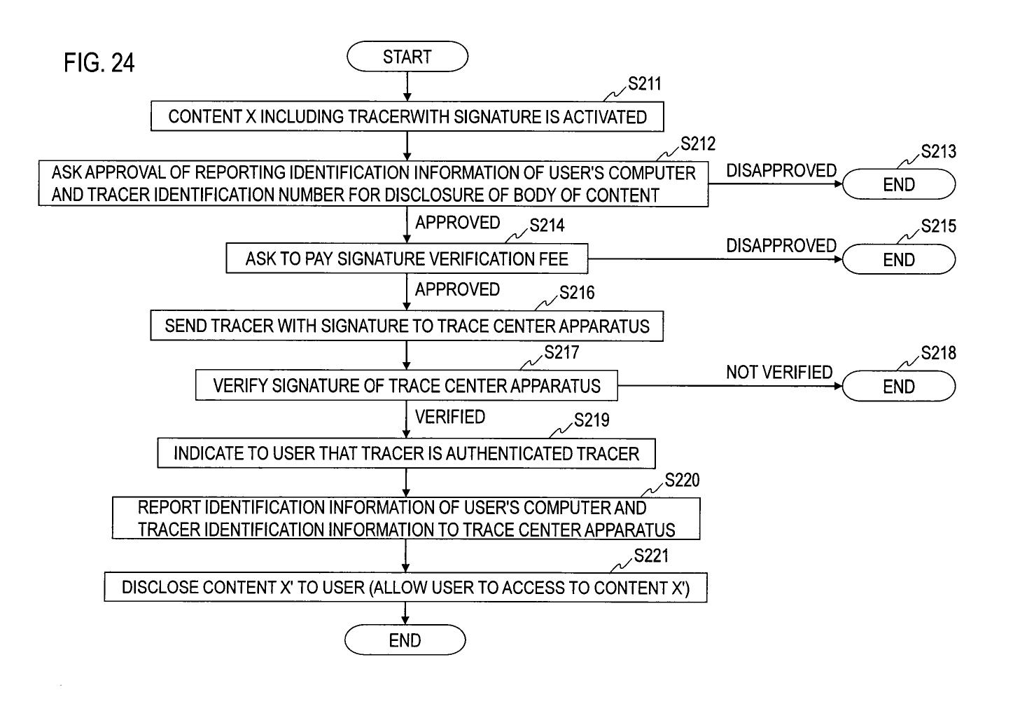

FIG. 23 illustrates a generation and registration procedure performed in the trace center apparatus according to the eighth embodiment. A content to be made traceable (hereinafter referred to as the content X′) is chosen on the computer 3A and is sent to the trace center apparatus 1 (step S201). The trace center apparatus 1 asks for payment of a registration fee (step S202), confirms payment of the registration fee (step S203), and generates a tracer which executes a process described later and illustrated in FIG. 24 (step S204). The trace center apparatus 1 adds a signature to the tracer by using a secret key of the trace center apparatus 1 (step S205), includes the tracer with the signature in the content X′ (hereinafter the resulting content is labeled with X) (step S206), registers the tracer with the signature and the content X′ in the trace center apparatus 1 (step S207), and sends the content X including the tracer with the signature to the computer 3A (step S208).

FIG. 24 illustrates a procedure performed by a tracer according to the eighth embodiment. When a content X including a tracer with a signature is activated (step S211), the tracer asks the user for approval of reporting identification information of the user's computer and the tracer identification number to the trace center apparatus 1 for disclosure of the body of the content (step S212). If the user does not approve the reporting, the tracer ends and the content is not disclosed to the user (step S213). If the user approves the reporting, the tracer asks the user for payment of a signature verification fee (step S214). If the user does not approve the payment, the tracer ends (step S215). If the user approves the payment, a file of the tracer with the signature is sent to the trace center apparatus 1 (step S216), where the signature of the tracer is verified by suing a public key of the trace center apparatus 1 (step S217). If an indication that the verification of the signature by the trace center apparatus 1 has failed is sent to the tracer, the tracer ends (step S218). If an indication that the signature has been successfully verified by the trace center apparatus 1 (i.e. it has been verified that the tracer is authentic) is sent to the tracer, the tracer indicates the fact to the user (step S219). Since the user has approved reporting of the identification information of the user's computer and the tracer identification number previously, the tracer reports the identification information of the user's computer and the tracer identification number to the trace center apparatus 1 (step S220) and discloses the body of the content X′ to the user (step S221).

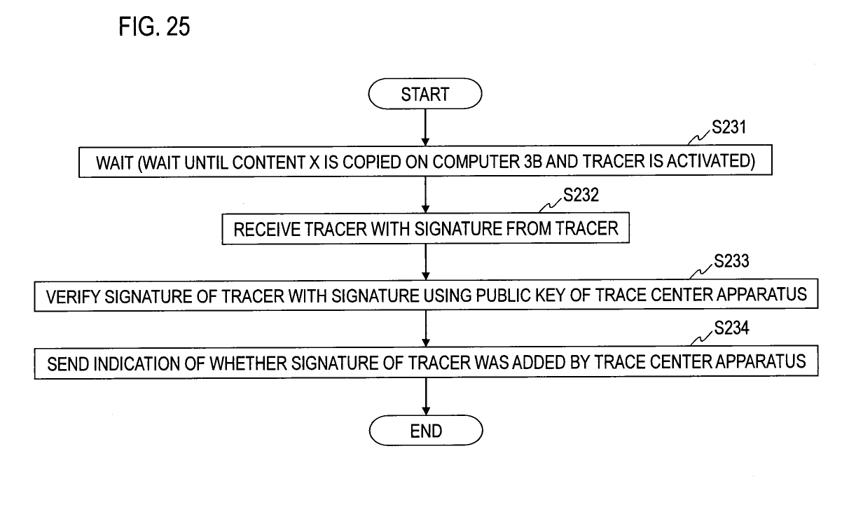

FIG. 25 illustrates a procedure for verifying a signature performed in the trace center apparatus 1 according to the eighth embodiment. The trace center apparatus 1 waits until a content X including a tracer with a signature is copied on the computer 3B and the tracer is activated (step S231), then the communication processing part 17 receives the tracer with the signature from the tracer (step S232). The signature verification part 18 verifies the signature of the tracer with the signature by using a public key of the trace center apparatus 1 (step S233) and sends an indication of whether the signature of the tracer was added by the trace center apparatus 1 (step S234).

### Ninth Embodiment

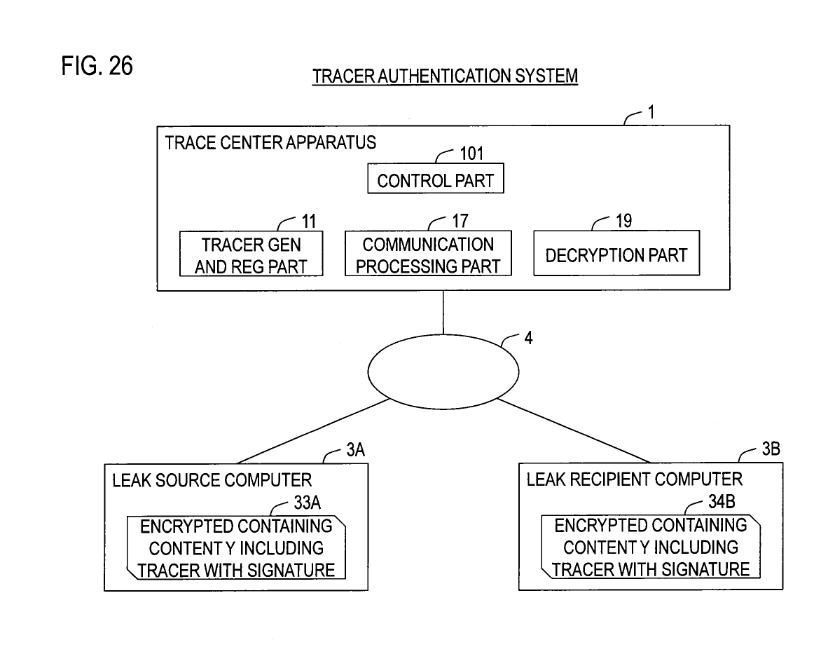

FIG. 26 is a system configuration diagram of a tracer authentication system according to a ninth embodiment. The tracer authentication system includes a trace center apparatus 1 and computes 3A, 3B. The trace center apparatus 1 and the computers 3A and 3B are connected to a network 4 such as the Internet or a LAN. The trace center apparatus 1 includes a control part 101, a tracer generation and registration part 11, and a communication processing part 17 like the trace center apparatus 1 according to the eighth embodiment, and further includes a decryption part 19. The trace center apparatus 1 executes processes under the control of the control part 101. The computer 3A is a leak source computer and the computer 3B is a leak recipient computer. It is assumed here that a content Y (34A, 34B) including a tracer with a signature is stored in both of the computers 3A and 3B. Although information leakage does not necessarily occur on the computers 3A, 3B, it is assumed in the following description that the computer 3A is a leak source computer and the computer 3B is a leak recipient computer, for illustrating how the leaked information tracing system works in the event of leakage.

When the tracer generation and registration part 11 receives a content from a computer, the tracer generation and registration part 11 issues a tracer identification number, generates a tracer having the function of reporting identification information of a computer on which the content resides and a tracer identification number, encrypts the content by using a public key of the trace center apparatus 1, includes the tracer into the encrypted content to generate an encrypted content including the tracer, registers the encrypted content including the tracer, and sends the encrypted content including the tracer to the computer. The communication processing part 17 receives identification information of a different or the same computer acquired and sent by the tracer in an encrypted content activated together with a tracer identification number after the encrypted content including the tracer has been copied on the different or the same computer. When the encrypted content is received from the tracer, the decryption part 19 decrypts the encrypted content by using a secret key of the trace center apparatus 1 and sends the decrypted content to the tracer.

In the tracer generation and registration part 11, the tracer is configured to be activated before the encrypted content is decrypted and is configured to ask to approve reporting of the identification information of a user's computer and the tracer identification number to the trace center apparatus 1 in order that the encrypted content can be decrypted and the body of the content can be disclosed. The tracer is configured to, if the user approves the reporting, send the encrypted contents to the trace center apparatus 1, receive the content decrypted by the decryption part 19 of the trace center apparatus 1, and disclose the body of the content to the user. The tracer is configured in the tracer generation and registration part 11 so as not to disclose the body of the content to the user if the user does not approve reporting the identification information of the user's computer and the tracer identification number to the trace center apparatus 1 for disclosure of the body of the decrypted content.

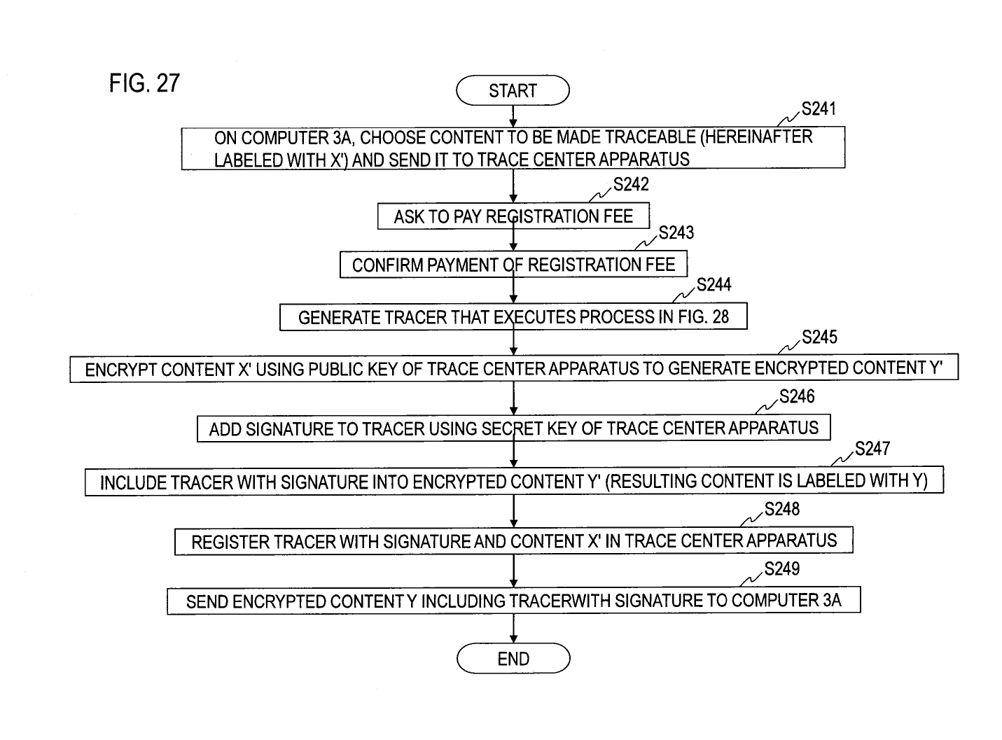

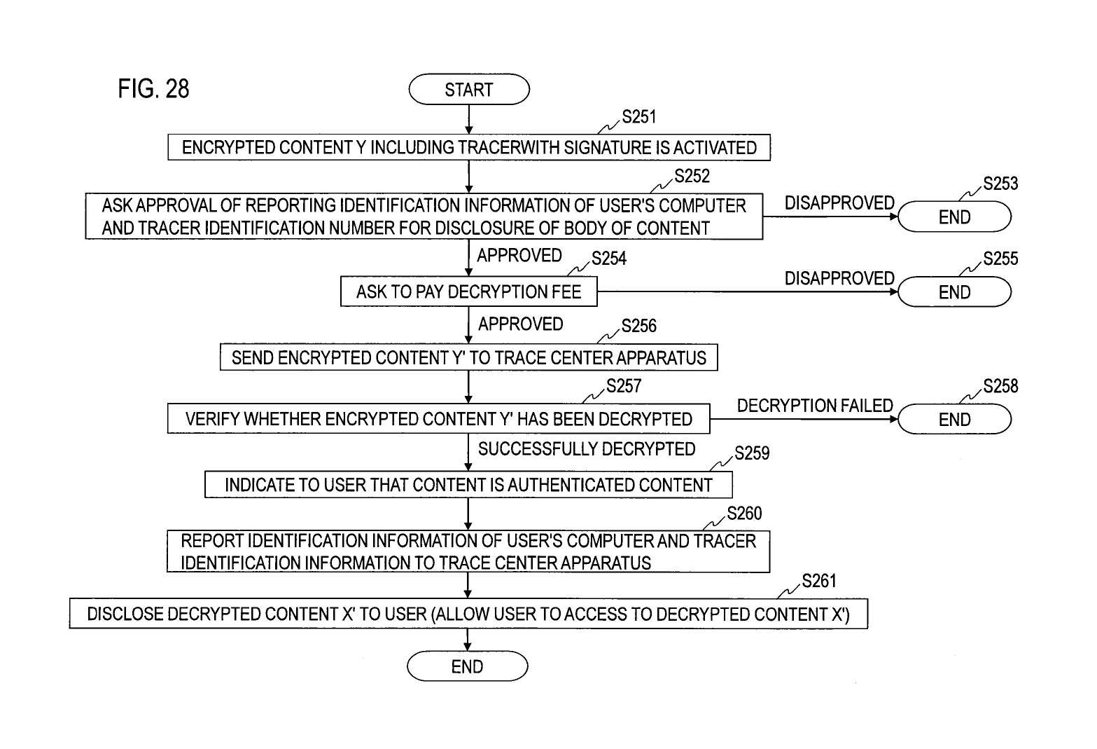

FIG. 27 illustrates a generation and registration procedure performed in the trace center apparatus according to the ninth embodiment. A content to be made traceable (hereinafter referred to as the content X′) is chosen on the computer 3A and is sent to the trace center apparatus 1 (step S241). The trace center apparatus 1 asks for payment of a registration fee (step S242), confirms payment of the registration fee (step S243), and generates a tracer which executes a process described later and illustrated in FIG. 28 (step S244). The trace center apparatus 1 encrypts the content X′ by using a public key of the trace center apparatus 1 to produce an encrypted content Y′ (step S245). The trace center apparatus 1 adds a signature to the tracer by using a secret key of the trace center apparatus 1 (S246), includes the tracer with the signature into the encrypted content Y′ (hereinafter the resulting content is labeled with Y) (step S247), registers the tracer with the signature and the content X′ in the trace center apparatus 1 (step S248), and sends the encrypted content Y including the tracer with the signature to the computer 3A (step S249).

FIG. 28 illustrates a procedure performed by a tracer according to the ninth embodiment. When an encrypted content Y including a tracer with a signature is activated (step S251), the tracer asks the user for approval of reporting identification information of the user's computer and the tracer identification number to the trace center apparatus 1 for disclosure of the body of the content (step S252). If the user does not approve the reporting, the tracer ends and the content is not disclosed to the user (step S253). If the user approves the reporting, the tracer asks the user for payment of a decryption fee (step S254). If the user does not approve the payment, the tracer ends (step S255). If the user approves the payment, an encrypted content Y′ is sent to the trace center apparatus 1 (step S256), where the encrypted content Y′ is decrypted by using a secret key of the trace center apparatus 1 to produce the content X′ (step S257). If an indication that decryption by the trace center apparatus 1 has been failed is sent to the tracer, tracer ends (step S258). When the content X′ decrypted by the trace center apparatus 1 is successfully received by the tracer (meaning that it has been verified that the content is authentic), the tracer indicates the fact to the user (step S259). Since the user has approved reporting of the identification information of the user's computer and the tracer identification number previously, the tracer reports the identification information of the user's computer and the tracer identification number to the trace center apparatus 1 (step S260) and discloses the decrypted content X′ to the user (step S261).

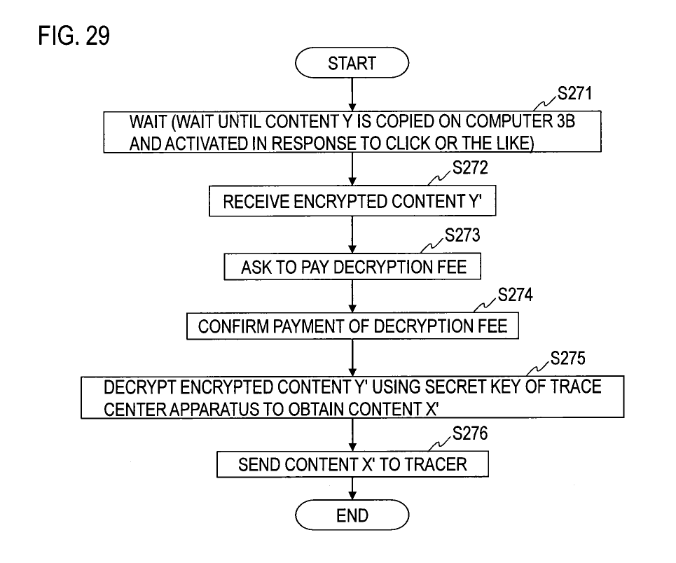

FIG. 29 illustrates a decryption procedure performed in the trace center apparatus according to the ninth embodiment. The trace center apparatus 1 waits until an encrypted content Y including a tracer with a signature is copied to the computer 3B and is activated in response to a click or the like (step S271), then the trace center apparatus 1 receives at the communication processing part 17 an encrypted content Y′ from the tracer (step S272). The trace center apparatus 1 asks for payment of a decryption fee (step S273), confirms the payment of the decryption fee (step S274), decrypts the encrypted content Y′ with a secret key of the trace center apparatus 1 to produce a decrypted content X′ (step S275), and sends the content X′ to the tracer (step S276).

The present invention is not limited to the embodiments described above. Modifications can be made as appropriate without departing from the spirit of the present invention. For example, any of the embodiments and modifications may be combined as appropriate.

1. A trace center apparatus comprising a tracer generation and registration part issuing a tracer identification number that uniquely identifies a content residing on a different computer and also uniquely identifies a tracer, generating a tracer program having the function of reporting identification information of a computer on which a content resides and the tracer identification number to a trace center while holding the trace identification number, and registering the tracer program with the trace center.

2. The trace center apparatus according to claim 1,
wherein the tracer generation and registration part is configured to receive the content from the different computer, include the tracer program in the content to generate a tracer-containing content, register the tracer-containing content with the trace center, and send the tracer-containing content to the different computer.

3. The trace center apparatus according to claim 1,
wherein the tracer generation and registration part is configured to send the tracer program to the different computer and to include the tracer program in the content to generate a tracer-containing content on the different computer.

4. The trace center apparatus according to claim 2 or 3,
wherein, after the content including the tracer is copied to another or the same computer, the tracer is activated, acquires identification information concerning the computer and sends the computer identification information and the tracer identification number, and the trace center apparatus further comprises an information receiving part receiving the computer identification information and the tracer identification number.

5. The trace center apparatus according to claim 4, comprising an additional program sending part sending an additional program embeddable in the tracer to the tracer program,
wherein in the tracer generation and registration part, the tracer program is configured to receive the additional program from the additional program sending part and is capable of embedding the additional program into the tracer program, and is configured to acquire system environment information of the different computer and send the system environment information to the trace center; and
the additional program sending part is configured to select a type of an additional program to be sent to the tracer program in accordance with the received system environment information of the different computer.

6. The trace center apparatus according to claim 4,
wherein when the trace center apparatus receives a registration fee from a user, the tracer generation and registration part generates the content including a tracing function, registers the content including the tracing function, and sends the content including the tracing function to the user and, when the trace center apparatus receives a report fee from the user, the tracer generation and registration part reports identification information of a leak recipient computer to the user.

7. The trace center apparatus according to claim 4, comprising:
a billing part providing a notification of a registration fee or a report fee to a relevant computer and receiving a payment from the relevant computer; and
a report processing part reporting at least an identification number of a leak recipient computer to an information source computer.

8. The trace center apparatus according to claim 4,
wherein when the trace center apparatus receives the content from a computer, the tracer generation and registration part issues the tracer identification number, generates the tracer having the function of reporting identification information of a computer on which the content resides and the tracer identification number, adds an electronic signature to the tracer by using a secret key of the trace center, includes the tracer with the signature into the content, registers the tracer with the signature or the content including the tracer with the signature, and sends the content including the tracer with the signature to the computer;
the trace center apparatus comprises a signature verification part configured to verify a signature of a tracer with the signature by using a public key of the trace center and send the result of the verification to the tracer;
the tracer is configured in the tracer generation and registration part so as to be activated before a body of the content is disclosed;
the tracer is configured to ask for approval of reporting identification information of the user's computer and the tracer identification number to the trace center in order that the body of the content can be disclosed;
the tracer is configured to send the tracer with the signature to the trace center if the user approves the reporting, and is configured to disclose the body of the content to the user if the tracer receives an indication that the signature verification part of the trace center has successfully verified that the signature of the tracer has been added by the trace center.

9. The trace center apparatus according to claim 1,
wherein in the tracer generation and registration part, a content is reconstructed, on the basis of the content, in an executable format that prevents access to the content unless certain preprocessing is executed and the tracer program is configured so as to be activated during the preprocessing.

10. The trace center apparatus according to claim 9, wherein in the tracer generation and registration part, the content is reconstructed in a self-extract format on the basis of the content.

11. A method for enabling a content to be traced, the method comprising the steps of:
issuing a tracer identification number uniquely identifying a content residing on a different computer and also uniquely identifying a tracer;
generating a tracer program including the function of reporting identification information of a computer on which the content resides and the trace identification number to a trace center while holding the tracer identification number; and
registering the tracer program with the trace center.
